(19) United States
(12) Patent Application Publication
(10) Pub. No.: US 2026/0230572 A1
(43) Pub. Date: Aug. 6, 2026

(54) Information Processing Apparatus and Computer Program

(71) Applicant: Sony Group Corporation, Tokyo (JP)

(72) Inventor: Masahiro Take, Kanagawa (JP)

(73) Assignee: Sony Group Corporation, Tokyo (JP)

(21) Appl. No.: 19/149,714

(22) PCT Filed: Mar. 13, 2024
(86) PCT No.: PCT/JP2024/009732

§ 371 Date: Jul. 21, 2025

(30) Foreign Application Priority Data
Mar. 20, 2023 (JP) 2023-043985

(51) Int. Cl. H04N 1/60

(52) U.S. Cl. CPC H04N 1/6086; H04N 1/6088

(57) ABSTRACT

There is provided an information processing apparatus that reproduces, on an observation side, the color of a subject on an image capturing side.

SOLUTION: An information processing apparatus comprising: at least one processor to implement: a selection unit configured to select r sample colors from among n sample colors, where n and r are both positive integers and n>r; a first acquisition unit configured to acquire RGB values that an imaging device outputs when the imaging device captures, in an image capturing environment, an image having each of the r sample colors selected by the selection unit; a second acquisition unit configured to acquire XYZ values that are obtained when the r sample colors selected by the selection unit are observed in an observation environment; a conversion information calculation unit configured to calculate conversion information for converting RGB values into XYZ values, based on the RGB values acquired by the first acquisition unit and the XYZ values acquired by the second acquisition unit; and an error calculation unit configured to calculate an error in the conversion information calculated by the conversion information calculation unit, wherein the selection unit is configured to select r sample colors from n sample colors, based on the error.

### TECHNICAL FIELD

The technique disclosed in the present description (hereinafter, referred to as “the present disclosure”) relates to an information processing apparatus and a computer program for processing color information.

### BACKGROUND ART

In most cases where an image of a subject captured by a camera is observed at a remote location, there is a problem in that accurate colors cannot be reproduced. The wording “a remote location” used here refers to, for example, an observation environment having a light source or the like different from that in an image capturing environment for a camera, and the image capturing environment and the observation environment are not necessarily distant physically from each other. In addition, the wording “an image is observed” refers to a case where an image is displayed on a screen of a display device. Therefore, the wording “the colors cannot be reproduced” refers to a case where the color of the subject in the image capturing environment cannot be accurately displayed on the display screen. The accurate color in this context is the color of the subject observed in the observation environment. The accurate color fails to be reproduced due to, for example, the setting and characteristics of equipment (such as a camera) and the difference in ambient light sources on the image capturing side and the observation side.

For example, an information processing apparatus is proposed that acquires characteristic data relating to spectral sensitivity characteristics of an imaging device, image capturing side spectral data relating to spectral distribution characteristics of a light source in an image capturing environment in which the imaging device performs image capturing, and color spectral data relating to spectral reflectance characteristics of a predetermined sample color and calculates an RGB value output from the imaging device when the imaging device captures an image of the predetermined sample color by using the characteristic data, the image capturing side spectral data, and the color spectral data; the information processing apparatus also acquires display side spectral data relating to spectral distribution characteristics of a light source in a display environment in which the image data captured by the imaging device is displayed on a display device and calculates an XYZ value used when the predetermined sample color is displayed on the display device by using the display side spectral data and the color spectral data described above; and the information processing apparatus further calculates conversion information for converting the RGB value into the XYZ value (see PTL 1).

### CITATION LIST

### Patent Literature

### [PTL 1]

JP 2022-182590A

### SUMMARY

### Technical Problem

An object of the present disclosure is to provide an information processing apparatus and a computer program for processing color information used for reproducing, on an observation side, the color of a subject on an image capturing side.

### Solution to Problem

The present disclosure has been made in view of the above problems, and according to the first aspect of the present disclosure, an information processing apparatus includes:
at least one processor to implement
a selection unit configured to select r sample colors from among n sample colors, where n and r are both positive integers and n>r;
a first acquisition unit configured to acquire RGB values that an imaging device outputs when the imaging device captures, in an image capturing environment,
an image having each of the r sample colors selected by the selection unit; a second acquisition unit configured to acquire XYZ values that are obtained when the r sample colors selected by the selection unit are observed in an observation environment;
a conversion information calculation unit configured to calculate conversion information for converting RGB values into XYZ values, based on the RGB values acquired by the first acquisition unit and the XYZ values acquired by the second acquisition unit; and
an error calculation unit configured to calculate an error in the conversion information calculated by the conversion information calculation unit,
wherein the selection unit is configured to select r sample colors from n sample colors, based on the error.

The selection unit is configured to select r sample colors from n sample colors such that the error is minimized.

The first acquisition unit may calculate RGB values that the imaging device outputs when the imaging device captures an image of the r sample colors selected by the selection unit, based on spectral reflectance characteristics of each of the r sample colors selected by the selection unit, spectral sensitivity characteristics of the imaging device, and spectral distribution characteristics of an imaging light source in the image capturing environment.

The second acquisition unit may calculate, based on a color-matching function, XYZ values that are obtained when each of the r sample colors selected by the selection unit is observed by using spectral distribution characteristics of an observation light source in the observation environment.

The information processing apparatus according to the first aspect may be further configured such that the at least one processor is operable to implement: a third acquisition unit configured to acquire accuracy evaluation RGB values that the imaging device outputs when the imaging device captures an image of accuracy evaluation sample colors in the image capturing environment; and a fourth acquisition unit configured to acquire accuracy evaluation XYZ values that are obtained when the accuracy evaluation sample colors are observed in the observation environment

In addition, the error calculation unit may be configured to calculate an error in the conversion information by using the accuracy evaluation RGB values and the accuracy evaluation XYZ values. The error calculation unit may be configured to set a target of error calculation, based on a target of color reproduction or an application field of the conversion information.

The selection unit may be configured to select r sample colors form n sample colors such that the error is minimized by using a generalized reduced gradient method.

According to the second aspect of the present disclosure, a computer program is computer-readable and causes a computer to function as:
a selection unit configured to select r sample colors from among n sample colors, where n and r are both positive integers and n>r;
a first acquisition unit configured to acquire RGB values that an imaging device outputs when the imaging device captures, in an image capturing environment,
an image having the r sample colors selected by the selection unit;
a second acquisition unit configured to acquire XYZ values that are obtained when the r sample colors selected by the selection unit are observed in an observation environment;
a conversion information calculation unit configured to calculate conversion information for converting RGB values into XYZ values, based on the RGB values acquired by the first acquisition unit and the XYZ values acquired by the second acquisition unit; and
an error calculation unit configured to calculate an error in the conversion information calculated by the conversion information calculation unit,
wherein the selection unit is configured to select r sample colors from n sample colors, based on the error.

A computer program according to the second aspect of the present disclosure defines a computer program written in a computer-readable format so as to realize predetermined processing on a computer. The computer program can be provided to a computer capable of executing various program codes by a storage medium provided in a computer-readable format or a communication medium, for example, a storage medium such as an optical disc, a magnetic disk, and a semiconductor memory, or a communication medium such as a network. By installing the computer program according to the second aspect of the present disclosure in the computer via any one of the media, collaborative effects are exerted on the computer, and the same operational effects as the information processing apparatus according to the first aspect of the present disclosure can be obtained.

According to the third aspect of the present disclosure, an information processing apparatus converting RGB values, output from an imaging device, into XYZ values by using conversion information, wherein the conversion information is calculated by using optimal r sample colors selected from among n sample colors, where n and r are both positive integers and n>r, so as to convert RGB values output from the imaging device that has captured an image comprising the optimal r sample colors into XYZ values that are obtained when the optimal r sample colors are observed in an observation environment.

### Advantageous Effects of Invention

According to the present disclosure, there are provided an information processing apparatus and a computer program for realizing color reproduction with high accuracy by using a combination of optimally selected sample colors to calculate conversion information.

It should be noted that the effects described in the present description are merely examples, and the effects brought by the present disclosure are not limited thereto. In addition to the above-described effects, the present disclosure may further provide additional effects.

Other objects, features, and advantages of the present disclosure will become apparent from the detailed description based on the embodiment described below and the accompanying drawings.

### BRIEF DESCRIPTION OF DRAWINGS

FIG. 1 is a diagram illustrating an example of a functional configuration of an information processing apparatus 100.

FIG. 2 is a diagram illustrating an example of a method for comparing camera-output XYZ values with observed XYZ values.

FIG. 3 is a diagram illustrating another method for comparing camera-output XYZ values with observed XYZ values.

FIG. 4 is a diagram illustrating an example of results obtained by calculating conversion coefficients for converting RGB values into XYZ values by using a least squares method.

FIG. 5 is a diagram illustrating another example of results obtained by calculating conversion coefficients for converting RGB values into XYZ values by using the least squares method.

FIG. 6 is a diagram illustrating a functional configuration of the information processing apparatus 100 that acquires RGB values by actually performing image capturing (in a case where equipment can be specified).

FIG. 7 is a diagram illustrating a functional configuration of the information processing apparatus 100 that acquires RGB values by actually performing image capturing (in a case where equipment cannot be specified).

FIG. 8 is a diagram illustrating a functional configuration of the information processing apparatus 100 when RGB values are obtained by calculation.

FIG. 9 is a diagram illustrating an implementation example in which most of the components of the information processing apparatus 100 are realized by a server.

FIG. 10 is a diagram illustrating an implementation example in which most of the components of the information processing apparatus 100 are realized on an image capturing side.

FIG. 11 is a diagram illustrating an implementation example in which most of the components of the information processing apparatus 100 are realized on an observation side.

FIG. 12 is a diagram illustrating a functional configuration of a camera 1200.

FIG. 13 is a diagram illustrating a functional configuration of a display device 1300.

FIG. 14 is a diagram illustrating a functional configuration for theoretically calculating an error in conversion coefficients calculated by using sample colors selected based on the present disclosure.

FIG. 15 is a diagram illustrating a functional configuration for theoretically calculating an error in conversion coefficients calculated by using sample colors empirically selected.

FIG. 16 is a diagram illustrating a functional configuration for theoretically calculating an error in conversion coefficients calculated by using all 24 colors of a Macbeth color chart.

FIG. 17 is a diagram illustrating a Macbeth color chart.

FIG. 18 is a diagram illustrating an example of 9 colors empirically selected from 24 colors of the Macbeth color chart.

FIG. 19 is a diagram illustrating an example of target setting in the method for comparing the camera output XYZ values with the observed XYZ values illustrated in FIG. 2.

FIG. 20 is a flowchart illustrating a processing procedure for selecting an optimal combination of colors in the information processing apparatus 100.

FIG. 21 is a diagram illustrating an example of a hardware configuration of the information processing apparatus 100.

FIG. 22 is a diagram illustrating a schematic configuration of a color reproduction system 2200 for reproducing accurate colors of a remote image.

### DESCRIPTION OF EMBODIMENTS

Hereinafter, an embodiment of the present disclosure will be described with reference to the drawings in the following order.
A. Overview
A-1. Overview of Color Reproduction System
A-2. Technical Problem and Solution
B. Functional Configuration
C. Error Calculation
D. Optimization Algorithm
E. RGB→XYZ Conversion
F. Functional Configuration in Accordance with RGB Value Acquisition Method
F-1. Case of Acquiring RGB Values by Actually Performing Image Capturing
F-2. Case of Obtaining RGB Values by Calculation
F-3. Implementation Examples
F-4. Functional Configuration of Camera
F-5. Functional Configuration of Display Device
G. Theoretical Calculation of Error
H. Processing Flow
I. Effects
J. Hardware Configuration of Information Processing Apparatus

### A. Overview

### A-1. Overview of Color Reproduction System

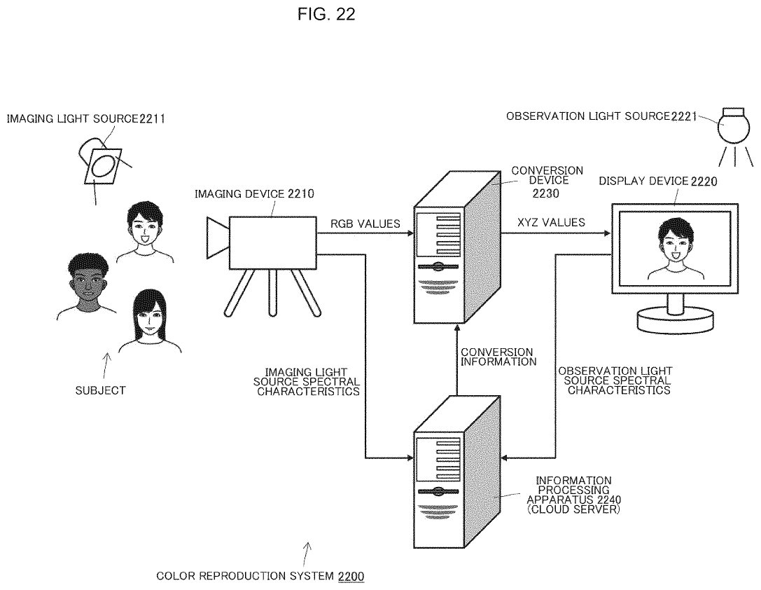

FIG. 22 schematically illustrates a configuration of a color reproduction system 2200 that reproduces accurate colors in most cases where an image of a subject captured by a camera is observed at a remote location. The illustrated color reproduction system 2200 includes an imaging device 2210, a display device 2220, a conversion device 2230, and an information processing apparatus 2240.

The imaging device 2210 captures an image of a subject in an image capturing environment in which an imaging light source 2211 is installed. The display device 2220 displays the image captured by the imaging device 2210 for an observer (not illustrated) at a remote location, in other words, in an observation environment in which an observation light source 2221 is installed and which is different from the image capturing environment.

When the image captured by the imaging device 2210 is displayed on the display device 2220, there are cases where it is desired to estimate a color of a subject visually recognized by the observer in the observation environment in which the observation light source 2221 is used as an observation side light source and to reproduce the color on the display device 2220.

An example of such a case is where an image obtained by capturing a patient in a hospital A (by the imaging device 2210) is displayed on a monitor (the display device 2220) in another hospital B and a doctor (observer) performs a medical examination. In this case, by reproducing a facial color of the patient displayed on the monitor in the same color as in the case where the doctor observes the facial color in the hospital B, the doctor can remotely examine the patient in the hospital A in a similar manner to the case where the doctor examines the patient in the hospital B. In telemedicine, if the color of the remote image cannot be accurately displayed, the diagnosis by the doctor may be seriously affected.

As a method for reproducing a color under the observation light source 2221 from an image captured by the imaging device 2210, there is a method for obtaining a color coordinate RGB value of the captured image as an absolute color coordinate XYZ value. In the color reproduction system 2200, by acquiring the color coordinates of the subject and the imaging light source 2211 as XYZ values, the absolute coordinates of the colors from the image capturing by the imaging device 2210 to the display by the display device 2220 can be held. Note that, in the XYZ color system, X is a value indicating the intensity of red, Y is a value indicating the intensity and brightness (luminance) of green, and Z is a value indicating the intensity of blue, and unlike the RGB color system, the XYZ color system can express all colors.

The imaging device 2210 may be a so-called “XYZ camera”, which mimics the spectral characteristics of the human eye. However, XYZ cameras are expensive and uncommon. Therefore, in the color reproduction system 2200, it is assumed that a so-called “RGB camera”, which captures an RGB image, is used as the imaging device 2210. The conversion device 2230 then performs conversion processing for converting device-dependent RGB values into XYZ values to acquire the captured image with the XYZ values. In this way, color reproducibility on the display device 2220 can be realized.

The information processing apparatus 2240 generates conversion information to be used in conversion processing for converting RGB values into XYZ values in the conversion device 2230. That is, when the image (RGB values) captured by the imaging device 2210 in the image capturing environment is displayed on the display device 2220 in the observation environment, the information processing apparatus 2240 generates conversion information for displaying, on the display device 2220, the same colors (XYZ values) as the colors visually recognized when the observer directly observes the subject. The information processing apparatus 2240 uses respective pieces of spectral characteristic data of the imaging light source 2211 and the observation light source 2221 when calculating the conversion information. The information processing apparatus 2240 may be, for example, a general arithmetic processing apparatus such as a personal computer (PC), or at least a part of the functions for generating the conversion information may be realized by a cloud server.

### A-2. Technical Problem and Solution

As a method for generating conversion information for converting RGB values of an RGB image captured by a camera into XYZ values, for example, the following two methods are applicable.
(1) A (printed) color chart having known spectral reflectance characteristics is captured by a camera, and color reproduction values of the same color chart in an observation environment are calculated in advance. By comparing the calculated color reproduction values with camera-output values, conversion coefficients are calculated based on data for correction.
(2) As described in PTL 1, by using characteristic data relating to spectral sensitivity characteristics (spectral characteristics of a color filter (CF)) of a camera that captures an image and spectral characteristics of each light source in an image capturing environment and an observation environment, conversion coefficients are calculated based on spectral reflectance characteristics of sample colors (sample color spectral data) held as data.

Objects of both methods (1) and (2) described above are to achieve more accurate color reproduction (that is, color matching) in a limited range of equipment and environment.

In addition, while methods (1) and (2) described above are common in that the conversion coefficients are calculated by using a color chart having known spectral reflectance characteristics, methods (1) and (2) differ in that an image of a printed color chart is actually captured by a camera in method (1), whereas the spectral reflectance characteristics of sample colors are held as data and an image of a color chart is virtually captured (that is, the RGB values of the image captured by the camera are obtained by calculation) in method (2). In either of the methods, since the color chart serves as a reference for color matching, the contents (the number of sample colors) of the color chart are very important.

In method (2), since the spectral reflectance characteristic data of the color chart is held and the RGB values of the image captured by the camera are obtained by calculation, there is practically no restriction on the number of colors. Whereas, in method (1), since an image of the printed color chart is actually captured by the camera, a fewer number of colors are better in terms of printing cost. Furthermore, as described above, since the color chart serves as a reference for color matching, both the printing cost and the matching accuracy need to be satisfied.

At the time of filing the present application, there is no clear method for determining a combination of colors for a color chart. For example, a Macbeth color chart, widely known as a “Macbeth chart” using 24 colors, is used, or some of or all of a plurality of existing color charts are selected and used. While the Macbeth color chart defines spectral reflectance characteristics of 24 colors and can be used as a color chart, the Macbeth color chart is not commonly applied to the color reproduction (or to the calculation of conversion information) from the viewpoint of its cost and availability.

In the present disclosure, the number of colors for the color chart used for generating conversion information is set to nine. Nine colors means that, for example, 9 colors are selected from among 24 colors whose spectral reflectances are defined in the source Macbeth color chart. In other words, in the present disclosure, a color chart composed of a combination of r colors selected from among n colors having known spectral reflectances is used for generating conversion information (where n and r are both positive integers and n>r).

When 9 colors are selected from source 24 colors of the Macbeth color chart, a selection method adapted to a matching target (or to an application field to which the color reproduction is applied) is considered to be used. For example, in a case where a matching target is to reproduce the color of human skin with high accuracy, it is empirically conceivable that conversion information is generated by using a color chart composed of 9 colors including a skin color as a central color, three primary colors of R, G, and B, shades of gray, etc. However, the 9 colors selected in this manner are not necessarily the most suitable for the matching target. In the first place, there is no reason to assume that matching accuracy is improved by using a combination of colors empirically selected for the color chart. In addition, the matching accuracy is assumed to be affected by equipment such as a camera, an image capturing side light source, and an observation side light source. However, the empirical rule of “the color of human skin=three primary colors of R, G, and B and shades of gray” does not compensate for the effects of equipment.

Therefore, in the present description, the present disclosure proposes a technique for selecting an optimal combination of colors to be used for a color chart in accordance with a matching target (or an application field to which the color reproduction is applied). In addition, the present disclosure proposes a technique for selecting an optimal combination of colors to be used for a color chart in view of the effects of equipment.

### B. Functional Configuration

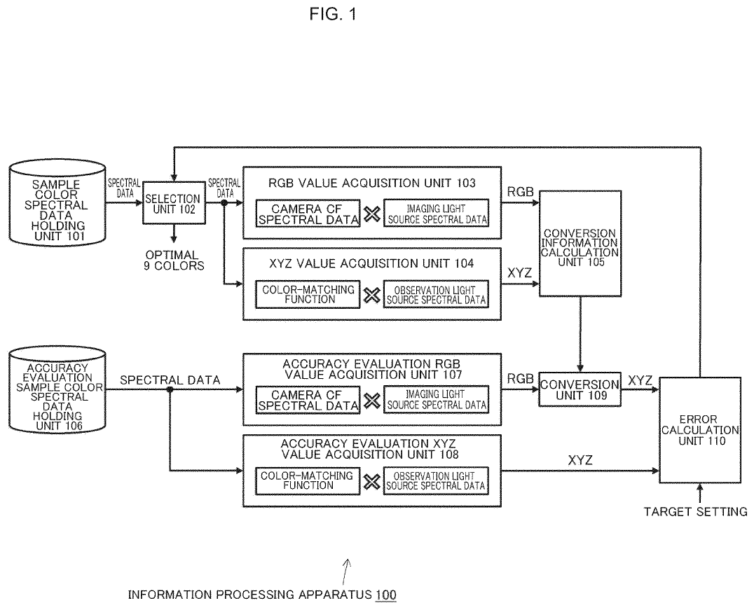

FIG. 1 illustrates an example of a functional configuration of an information processing apparatus 100 applied to the present disclosure. The information processing apparatus 100 performs processing for selecting r optimal colors as a color chart used for generating conversion information for converting RGB values into XYZ values in accordance with a matching target (or an application field to which the color reproduction is applied) from among n colors having known spectral reflectances (where n and r are both positive integers and n>r). For example, the information processing apparatus 100 may be a general arithmetic processing apparatus such as a PC, or at least a part of the functions of the components in FIG. 1 may be realized by a cloud server.

A sample color spectral data holding unit 101 holds spectral reflectance data of each of the n sample colors serving as a selection source. In the following description, a Macbeth color chart is assumed to be used as the selection source, and the sample color spectral data holding unit 101 holds spectral reflectance data of each of the 24 sample colors included in the Macbeth color chart.

A selection unit 102 selects r sample colors from among the n sample colors serving as a selection source, reads the spectral reflectance data of each of the selected sample colors from the sample color spectral data holding unit 101, and outputs the read spectral reflectance data to the functional block in the subsequent stage. In the following description, it is assumed that the Macbeth color chart is used as the selection source, and the selection unit 102 selects 9 sample colors from among the 24 colors included in the Macbeth color chart. Alternatively, a color chart composed of 9 sample colors selected by the selection unit 102 may be printed and passed to the functional block in the subsequent stage.

An RGB value acquisition unit 103 acquires RGB values that are obtained when a camera captures an image of a color chart composed of 9 sample colors selected by the selection unit 102 in the image capturing environment. The RGB value acquisition unit 103 can obtain, by calculation, RGB values that are obtained when an image of the color chart including the 9 colors is captured based on the spectral reflectance data of each of the 9 sample colors selected by the selection unit 102, the spectral sensitivity characteristic data of a color filter (CF) of the camera to be used, and the spectral distribution characteristic data of a light source (imaging light source) in the image capturing environment. Alternatively, the RGB value acquisition unit 103 may acquire RGB values output from the camera that has captured an image of the printed color chart in the image capturing environment.

An XYZ value acquisition unit 104 acquires, as target values, XYZ values that are obtained when the color chart composed of 9 sample colors selected by the selection unit 102 is observed in the observation environment. The XYZ value acquisition unit 104 can calculate, based on a color-matching function, XYZ values based on the spectral reflectance data of each of the 9 sample colors selected by the selection unit 102 and the spectral distribution characteristic data of a light source (observation light source) in the observation environment. When D65 (corresponding to light at average noon (light obtained by combining direct sunlight and diffused light from clear sky)) capable of providing neutral color reproduction is assumed as an observation light source, the XYZ value acquisition unit 104 may calculate, based on the color-matching function, XYZ values that are obtained when the 9 colors selected by the selection unit 102 are observed under the D65 light source.

A conversion information calculation unit 105 compares the camera output RGB values acquired by the RGB value acquisition unit 103 with the XYZ values acquired by the XYZ value acquisition unit 104 and calculates conversion information for converting the RGB values into the XYZ values by using the least squares method or the like. The conversion information includes, for example, conversion coefficients of a 3×3 matrix for converting RGB values into XYZ values. In a case where gamma correction has been performed on the output from the camera acquired by the RGB value acquisition unit 103 for transmission, first, inverse gamma correction is performed on the RGB values, and then, the RGB values are used for the calculation by the conversion information calculation unit 105.

An accuracy evaluation sample color spectral data holding unit 106 holds spectral reflectance data of each sample color for accuracy evaluation. For accuracy evaluation, a Macbeth color chart may be used as described above, or another color chart may be used for accuracy evaluation. When the same color chart is used, the sample color spectral data holding unit 101 and the accuracy evaluation sample color spectral data holding unit 106 may be shared.

An accuracy evaluation RGB value acquisition unit 107 acquires accuracy evaluation RGB values that are obtained when a camera captures an image of a color chart composed of accuracy evaluation sample colors in the image capturing environment. The accuracy evaluation RGB value acquisition unit 107 can obtain, by calculation, accuracy evaluation RGB values that are obtained when an image of the color chart is captured based on the spectral reflectance data of the accuracy evaluation sample colors, the spectral sensitivity characteristic data of a color filter of the camera to be used, and the spectral distribution characteristic data of an imaging light source. Alternatively, the accuracy evaluation RGB value acquisition unit 107 may acquire accuracy evaluation RGB values output from the camera that has captured an image of the printed color chart in the image capturing environment.

An accuracy evaluation XYZ value acquisition unit 108 acquires accuracy evaluation XYZ values that are obtained when the color chart composed of the accuracy evaluation sample colors is observed in the observation environment. The accuracy evaluation XYZ value acquisition unit 108 can calculate, based on the color-matching function, accuracy evaluation XYZ values based on the spectral reflectance data of the accuracy evaluation sample colors, the spectral distribution characteristic data of an observation light source. When D65 is assumed as the observation light source, the accuracy evaluation XYZ value acquisition unit 108 may calculate, based on the color-matching function, accuracy evaluation XYZ values that are obtained when the accuracy evaluation sample colors are observed under the D65 light source.

A conversion unit 109 converts the accuracy evaluation RGB values acquired by the accuracy evaluation RGB value acquisition unit 107 into XYZ values by using the conversion coefficients calculated by the conversion information calculation unit 105.

An error calculation unit 110 compares the XYZ values obtained after the conversion by the conversion unit 109 with the accuracy evaluation XYZ values acquired by the accuracy evaluation XYZ value acquisition unit 108 and calculates an error in the conversion coefficients calculated by the conversion information calculation unit 105.

The error calculated by the error calculation unit 110 is fed back to the selection unit 102. Next, the selection unit 102 selects 9 sample colors from among the 24 colors included in the Macbeth color chart again by using an optimization algorithm such that the error in the conversion coefficients is minimized.

The information processing apparatus 100 can select the optimal 9 colors by repeating the selection of the sample colors and the calculation of the error as described above.

The error calculation unit 110 may set a target of error calculation based on a target of color reproduction or an application field of the conversion information. For example, the target setting is to set a weight for each sample color based on a target of color reproduction or an application field of conversion information. The target setting enables processing such as increasing accuracy of a specific sample color.

According to the information processing apparatus 100 illustrated in FIG. 1, an optimal combination of sample colors can be selected as a color chart by determining equipment (the spectral sensitivity characteristic data of the color filter of the camera to be used) and environment (the spectral distribution characteristics of the imaging light source and the spectral distribution characteristics of the observation light source) and further performing target setting (weighting for each sample color in accordance with the application field or the like). As a result, highly accurate conversion coefficients can be calculated. The information processing apparatus 100 outputs the conversion information calculated by the error calculation unit 110 in accordance with the set target by using the color chart composed of the optimal combination of 9 colors to the conversion device (for example, the conversion device 2230 in FIG. 22) as the final conversion information.

### C. Error Calculation

Section C will describe two methods in each of which the error calculation unit 110 compares the XYZ values that are obtained through the accuracy evaluation RGB value acquisition unit 107 and that are the output from the camera that has captured the image of the accuracy evaluation color chart with the XYZ values that are obtained through the accuracy evaluation XYZ value acquisition unit 108 and that are obtained by observing the accuracy evaluation color chart in the observation environment.

In the first method, a first set of two-dimensional xy coordinates are calculated for the XYZ values converted from the accuracy evaluation RGB values and a second set of two-dimensional xy coordinates are calculated for the accuracy evaluation XYZ values, and at least one of following are calculated: (i) a sum of differences between corresponding coordinates of the first set and the second set (ii) an average and a standard deviation of differences between corresponding coordinates of the first set and the second set, (iii) a sum of absolute values of differences between corresponding coordinates of the first set and the second set, or (iv) an average of absolute values of differences between corresponding coordinates of the first set and the second set and a standard deviation of x value differences or y value differences between corresponding coordinates of the first set and the second set. The calculated value(s) of (i)-(iv) are used for optimizing the combination of sample colors in the selection unit 102.

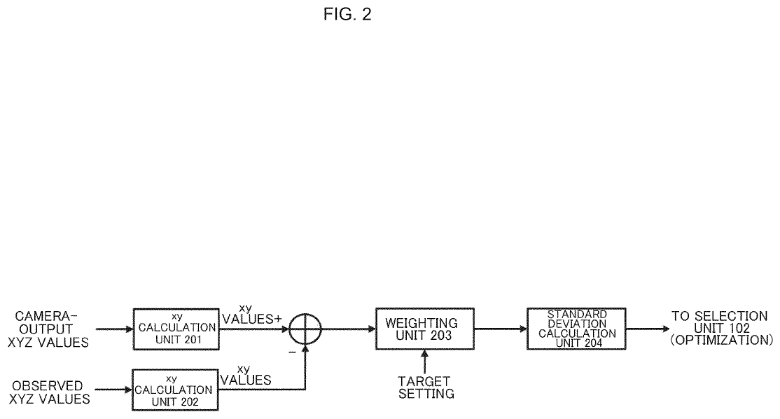

FIG. 2 illustrates an example of an internal configuration of the error calculation unit 110 that uses the first method for comparing the camera-output XYZ values with the observed XYZ values. In the configuration example illustrated in FIG. 2, first, an xy calculation unit 201 and an xy calculation unit 202 calculate two-dimensional xy coordinates for the camera-output XYZ values (corresponding to the output of the conversion unit 109) and the observed XYZ values (corresponding to the output of the accuracy evaluation XYZ value acquisition unit 108), respectively, and color differences therebetween are obtained on the xy coordinate system. The xy coordinates can be calculated from the XYZ values by using equations x=X/(X+Y+Z) and y=Y(X+Y+Z). Next, a weighting unit 203 assigns weights to each of the calculated color differences in accordance with the set target for each color, and a standard deviation calculation unit 204 then calculates a standard deviation.

Although the first method is simple, the calculation results do not necessarily match human perception. Alternatively, a method in which, instead of the xy coordinate values, u′v′ coordinate values are calculated from the camera output XYZ values and the observed XYZ values to calculate an error in the same manner as described above may be used.

In the second method, the camera-output XYZ values are compared with the observed XYZ values by using DE2000. DE2000 is known as a color difference evaluation method in view of human perception. When DE2000 is used, first, each of the camera-output XYZ values and the observed XYZ values is converted into an L*a*b* value. In an L*a*b* color system, L* is a value indicating brightness, a* is a value indicating the intensity of red (the greater a* is, the stronger red is, and the smaller a* is, the stronger green is), and b* is a value indicating the intensity of yellow (the greater b* is, the stronger yellow is, and the smaller b* is, the stronger blue is). For example, XYZ values can be converted into L*a*b* values by using a conversion program that is shared or published via a library. Next, an average, a sum, and a standard deviation of the DE2000 values are calculated for each sample color, and the obtained values are used for optimizing the combination of sample colors in the selection unit 102.

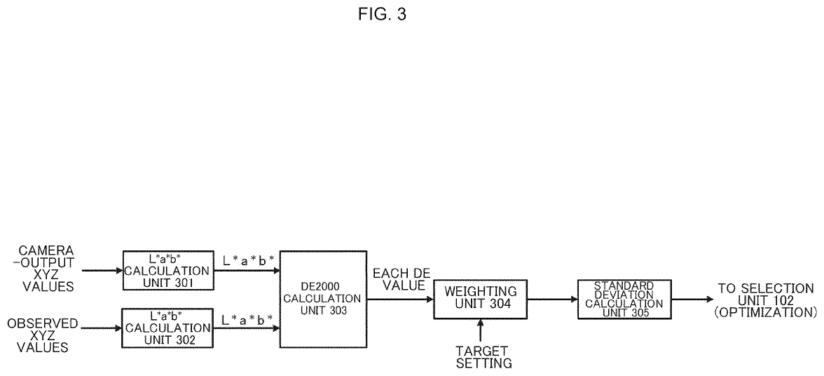

FIG. 3 illustrates an example of an internal configuration of the error calculation unit 110 that uses the second method for comparing the camera-output XYZ values with the observed XYZ values. In the configuration example illustrated in FIG. 3, first, an L*a*b* calculation unit 301 and an L*a*b* calculation unit 302 convert the camera-output XYZ values (corresponding to the output of the conversion unit 109) and the observed XYZ values (corresponding to the output of the accuracy evaluation XYZ value acquisition unit 108), respectively, into L*a*b* values for respective accuracy evaluation sample colors. The L*a*b* calculation units 301 and 302 may convert the XYZ values into L*a*b* values by using a conversion program that is shared or published via a library. Next, a DE2000 calculation unit 303 calculates a DE2000 value indicating a color difference between the L*a*b* values for each accuracy evaluation sample color. After a weighting unit 304 assigns weights to each DE2000 value calculated for each color in accordance with the set target, a standard deviation calculation unit 305 calculates the standard deviation of the DE2000 values for respective sample colors, and the obtained values are used for optimizing the combination of sample colors in the selection unit 102.

According to the second method, after the DE2000 value calculated for each color is weighted in accordance with the set target, the standard deviation is calculated. According to the method illustrated in FIG. 3, although the calculation of the DE2000 is complex, it is possible to perform optimization that is the closest to human perception.

Note that either of the two methods described above is capable of selecting an optimal combination of sample colors in the selection unit 102 to which the error is fed back by setting the target (that is, performing the weighting based on the set target in each of the weighting units 203 and 304).

### D. Optimization Algorithm

Section B above has described that the selection unit 102 uses the optimization algorithm to select 9 sample colors that minimize the error in the conversion coefficients from among the 24 colors included in the Macbeth color chart. In Section D, the optimization algorithm will be described.

The selection unit 102 selects r sample colors from among n sample colors serving as a selection source such that the value of the error fed back from the error calculation unit 110 is minimized. In the simplest method, errors are calculated for all possible combinations of r sample colors that can be selected from the n sample colors serving as the selection source, and a combination of r colors having the smallest error is selected. Naturally, since the information processing apparatus 100 needs to calculate conversion coefficients and errors repeatedly for ₙCᵣ times, an enormous amount of computation will be needed. When 9 sample colors are selected from among the 24 colors included in the Macbeth color chart, the number of computations is ₂₄C₉=1,307,504 times. In addition, when the RGB value acquisition unit 103 acquires RGB values by actually capturing an image of a printed color chart by a camera, 1,307,504 sheets of the color chart need to be printed, which is an excessive burden of the printing cost alone.

Therefore, it is desirable that the selection unit 102 use the optimization algorithm to select r sample colors from among the n sample colors serving as the selection source so as to avoid calculating all possible combinations.

The optimization algorithm used when implementing the present disclosure is not limited to any specific optimization algorithm. Any algorithm can be adopted as long as the purpose of reducing the amount of computation can be achieved. For example, optimization may be performed by using a generalized reduced gradient (GRG) method, which is a method obtained by generalizing a reduced gradient method used for a linear programming problem to be used for a nonlinear programming problem. In the GRG algorithm, a variable is moved while observing the change rate of a target value (in the present embodiment, a minimized value) when the variable is moved from an initial value, and when the change rate of the target value reaches a minimum value, a convergence solution is obtained.

### E. RGB→XYZ Conversion

The RGB value acquisition unit 103 can adopt either a method for acquiring RGB values by actually performing image capturing or a method for obtaining RGB values by calculation. In the former method, a color chart composed of 9 colors (temporarily) selected by the selection unit 102 is printed, and a camera captures an image of this color chart in the image capturing environment to acquire RGB values. In the latter method, RGB values that are obtained when an image of the color chart is captured are obtained by calculation based on the spectral reflectance data of each of the 9 sample colors (temporarily) selected by the selection unit 102, the spectral sensitivity characteristic data of a color filter of a camera to be used, and the spectral distribution characteristic data of a light source (imaging light source) in the image capturing environment.

Whichever RGB value acquisition method is used by the RGB value acquisition unit 103, the RGB values can be converted into XYZ values by using matrix conversion or RGB gain conversion, and the conversion information calculation unit 105 calculates conversion coefficients by using a least squares method or the like. In the latter RGB value acquisition method, in addition to matrix conversion, converting the RGB values into XYZ values by using a table (for example, see PTL 1) is also assumed. However, in view of comparison with the former RGB value acquisition method, it is assumed that the RGB values are converted into XYZ values by using matrix conversion in both of the RGB value acquisition methods in Section E.

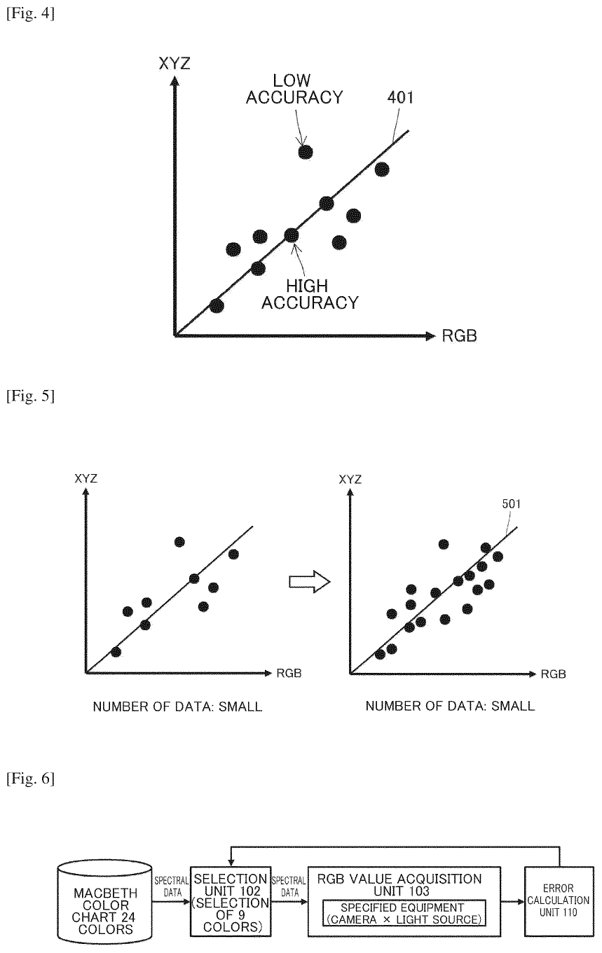

FIG. 4 illustrates an example of results obtained by calculating conversion coefficients for converting RGB values into XYZ values by using a least squares method. In FIG. 4, the relationship between input and output, that is, corresponding points between RGB values before conversion and XYZ values after conversion are plotted, and an approximate expression of input and output calculated by the least squares method is indicated by a straight line 401. As can be seen from FIG. 4, there are a case where the RGB values before conversion and the XYZ values after conversion are matched with high accuracy (“high accuracy” in FIG. 4) as indicated by points plotted near the approximate expression and a case where the RGB values before conversion and the XYZ values after conversion are matched with low accuracy (“low accuracy” in FIG. 4) as indicated by points plotted away from the approximate expression. That is, it can be said that variations in matching occur depending on the color.

The conversion matrix for converting RGB values into XYZ values is a 3×3 matrix, and thus, there are only 9 conversion coefficients, that is, the computational load is light so that the conversion itself can be performed with less hardware. However, since all the RGB values are converted by one set of coefficients, even if the conversion coefficients are calculated by the least squares method, variations in matching occur depending on the color as illustrated in FIG. 4.

FIG. 5 illustrates another example of results obtained by calculating conversion coefficients for converting RGB values into XYZ values by using the least squares method. There are more pieces of data (that is, the number of plotted corresponding points between the RGB values before conversion and the XYZ values after conversion) in the example illustrated in FIG. 5 than in the example illustrated in FIG. 4. In FIG. 5, the approximate expression of the input and output calculated by the least squares method is indicated by a straight line 501. It can be seen that even if the number of pieces of data is increased, the matching accuracy between the RGB values before conversion and the XYZ values after conversion is not good in some cases, and the variations in matching depending on the color is not eliminated. It is important that the data cover a necessary range (a color range in the present embodiment) comprehensively and equally, and it cannot be said that the accuracy of the conversion coefficients improves as the number of pieces of data increases.

### F. Functional Configuration in Accordance with RGB Value Acquisition Method

The RGB value acquisition unit 103 can adopt either a method for acquiring the RGB values by actually performing image capturing or a method for obtaining the RGB values by calculation. In Section F, a specific functional configuration of the information processing apparatus 100 in accordance with the RGB value acquisition method will be described.

### F-1. Case of Acquiring RGB Values by Actually Performing Image Capturing

In the method for acquiring the RGB values by actually performing image capturing, since a color chart needs to be printed in advance, r sample colors are selected from among the source n sample colors in a stage prior to the actual operation. The method for acquiring the RGB values by actually performing image capturing can be further divided into a case where equipment (a camera and an imaging light source) can be specified and a case where equipment cannot be specified.

FIG. 6 illustrates a functional configuration of the information processing apparatus 100 in a case where the equipment can be specified. Note that FIG. 6 illustrates, as an example, a case where 9 colors are selected from among the 24 colors of the source Macbeth color chart, and the components unnecessary for description are not illustrated. When the use is clearly determined, the equipment to be used is likely to have been determined, and in such a case, the information processing apparatus 100 illustrated in FIG. 6 can be selected.

When the equipment (the camera and the imaging light source) can be specified, the RGB value acquisition unit 103 acquires the RGB values that are obtained by capturing an image of a color chart composed of the 9 colors selected from the 24 colors of the Macbeth color chart by the specified equipment (that is, a combination of the specified camera and imaging light source) and are actually output from the camera. Next, the error calculation unit 110 calculates an error in the conversion coefficients obtained based on the RGB values that the RGB value acquisition unit 103 has acquired by actually capturing the image of the printed color chart, and feeds back the calculated error to the selection unit 102. Next, the selection unit 102 selects 9 sample colors from among the 24 colors included in the Macbeth color chart by using the optimization algorithm such that the error in the conversion coefficients is minimized.

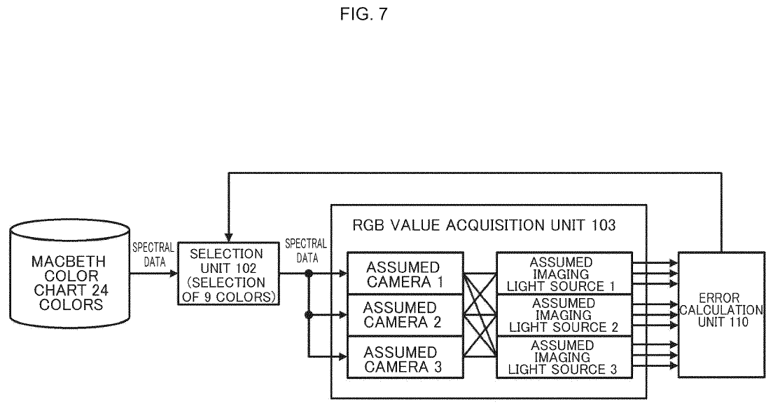

FIG. 7 illustrates a functional configuration of the information processing apparatus 100 in a case where the equipment cannot be specified. Note that FIG. 7 also illustrates, as an example, a case where 9 colors are selected from among the 24 colors of the source Macbeth color chart, and the components unnecessary for description are not illustrated.

When the equipment cannot be specified, some pieces of equipment may be assumed, and an error may be calculated for each combination. Next, 9 sample colors may be selected based on the average of the errors or the weights. In the example illustrated in FIG. 7, the RGB value acquisition unit 103 assumes three types of assumed cameras 1 to 3 as the camera and three types of assumed imaging light sources 1 to 3 as the imaging light source and acquires RGB values for each of the nine combinations in total, and the error calculation unit 110 calculates an error in the conversion coefficients obtained based on each of the acquired RGB values and feeds back the calculated error to the selection unit 102. Next, the selection unit 102 selects 9 sample colors from among the 24 colors included in the Macbeth color chart by using the optimization algorithm such that the error in the conversion coefficients is minimized.

For example, when a white light-emitting diode (LED), a fluorescent light, and a white light, which are three types of light sources used in general households, are assumed to serve as the imaging light sources 1 to 3 and when the household penetration ratio for these light sources are known, for example, as 5:3:2, by calculating the errors after weighting the value obtained from each light source based on the order or ratio of its penetration rate, it is possible to control to select 9 colors that provide the highest accuracy under the light source with a high penetration rate.

In FIG. 7, the XYZ value acquisition unit 104 is not illustrated. As already described above in Section B, the XYZ value acquisition unit 104 acquires XYZ values that are obtained when the color chart composed of the selected 9 colors is observed in the observation environment. As described above, D65 capable of providing neutral color reproduction is assumed as an observation light source. However, if there is another assumed light source, the XYZ value acquisition unit 104 may calculate conversion coefficients so as to acquire XYZ values and perform color reproduction by using the light source.

The processing for acquiring the RGB values from the selected sample colors may be performed on the actual equipment (equipment such as a camera) or on a computer. When the processing is performed on a computer, the spectral sensitivity characteristics of the color filter of the camera, the spectral distribution characteristics of the imaging light source, and the like need to be specified, or information about the optical characteristics of the assumed equipment needs to be prepared as data. On the other hand, when the actual equipment is used for acquiring the RGB values, the color chart composed of the sample colors selected by the selection unit 102 needs to be printed. In addition, since the processing for selecting the sample colors is performed in advance, the calculation time and the calculation resources are less likely to be constraints. The selection of the optimal solution can be facilitated by increasing the number of source colors from 24 colors, changing the 24 colors to a different combination of 24 colors, or increasing the number of pieces of assumed equipment.

### F-2. Case of Obtaining RGB Values by Calculation

In the method for obtaining RGB values by calculation, conversion coefficients are calculated on the assumption that the spectral sensitivity characteristics of the color filter of the camera, the spectral distribution characteristics of the imaging light source, and the spectral distribution characteristics of the observation light source are known in advance. These pieces of characteristic data can be acquired by any method, and the method is not particularly limited.

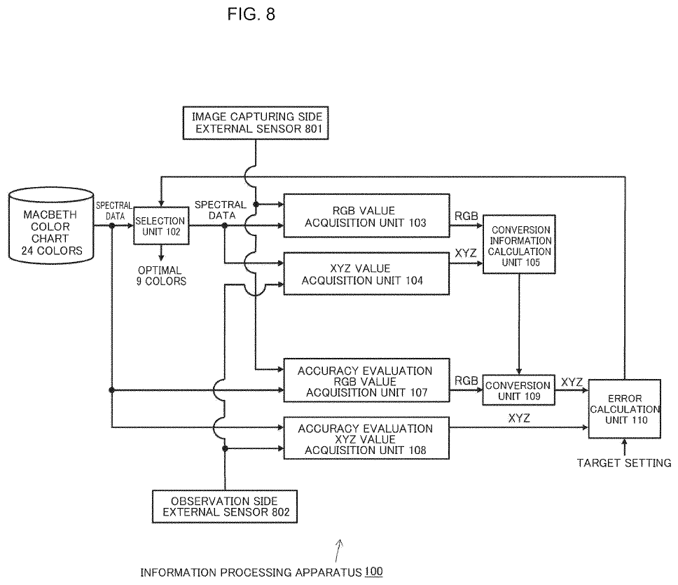

FIG. 8 illustrates a functional configuration of the information processing apparatus 100 in the case of obtaining RGB values by calculation. The information processing apparatus 100 illustrated in FIG. 8 is configured to use an image capturing side external sensor 801 and an observation side external sensor 802 (described below) to obtain information about the image capturing environment and the observation environment (spectral characteristics of each light source). In addition, in FIG. 8, for simplification, it is assumed that the same Macbeth color chart is used when conversion coefficients are calculated and when accuracy evaluation of the conversion coefficients are performed (that is, when an error is calculated). Therefore, the information processing apparatus 100 only includes the sample color spectral data holding unit 101, and the accuracy evaluation sample color spectral data holding unit 106 is omitted.

The selection unit 102 selects 9 sample colors from among the 24 colors included in the Macbeth color chart, reads the spectral reflectance data of each of the selected sample colors from the sample color spectral data holding unit 101, and outputs the read spectral reflectance data to the functional block in the subsequent stage.

Since, instead of printing the color chart, the data of each sample color included in the color chart is used, there is practically no restriction on the number of colors. However, as described above in Section E, it is important that the number of colors of the color chart comprehensively cover a necessary color range, and the accuracy is not necessarily improved by having a large amount of data (for example, see FIG. 5). Therefore, even when the RGB values are obtained by calculation, 9 sample colors among the 24 sample colors of the Macbeth color chart are similarly used for the calculation of conversion coefficients.

The RGB value acquisition unit 103 acquires the spectral sensitivity characteristics of the color filter of the camera to be actually used by using any method, for example, by acquiring the spectral sensitivity characteristic data of the color filter of the specified camera from a database storing the spectral sensitivity characteristics of the color filters of all the assumed cameras or by receiving the data from the camera as metadata.

In addition, the RGB value acquisition unit 103 acquires the spectral distribution characteristics of the imaging light source obtained by the image capturing side external sensor 801 installed in the image capturing environment or estimates the spectral distribution characteristics of the imaging light source from the values obtained from the image capturing side external sensor 801. For example, the image capturing side external sensor 801 may be mounted on a camera to be actually used, and the camera may transmit sensing data obtained by the image capturing side external sensor 801 to the information processing apparatus 100 (or the RGB value acquisition unit 103). Alternatively, the image capturing side external sensor 801 may be an external light sensor installed in the image capturing environment independently of the camera.

Next, the RGB value acquisition unit 103 calculates RGB values that are obtained when the camera captures an image of the color chart composed of the 9 sample colors based on the spectral reflectance data of each of the 9 sample colors selected by the selection unit 102, the spectral sensitivity characteristic data of the color filter of the camera obtained from the database or the camera, and the spectral distribution characteristic data of the imaging light source obtained from the image capturing side external sensor 801.

Whereas, the XYZ value acquisition unit 104 acquires the spectral distribution characteristics of the observation light source obtained by the observation side external sensor 802 installed in the observation environment or estimates the spectral distribution characteristics of the observation light source from the values obtained from the observation side external sensor 802. For example, the observation side external sensor 802 may be mounted on a display device that displays an image captured by the camera, and the display device may transmit sensing data obtained by the observation side external sensor 802 to the information processing apparatus 100 (or the XYZ value acquisition unit 104). Alternatively, the observation side external sensor 802 may be an external light sensor installed in the observation environment independently of the display device.

Next, the XYZ value acquisition unit 104 calculates, based on the color-matching function, XYZ values that are obtained when the color chart composed of the 9 sample colors selected by the selection unit 102 is observed in the observation environment based on the spectral reflectance data of each of the 9 sample colors selected by the selection unit 102 and the spectral distribution characteristic data of the observation light source obtained from the observation side external sensor 802.

The conversion information calculation unit 105 compares the camera-output RGB values acquired by the RGB value acquisition unit 103 with the XYZ values acquired by the XYZ value acquisition unit 104 and calculates conversion coefficients for converting the RGB values into XYZ values by using a least squares method or the like.

The accuracy evaluation RGB value acquisition unit 107 calculates RGB values that are obtained when the camera captures an image of a color chart composed of the 24 sample colors of the Macbeth color chart based on the spectral reflectance data of the 24 sample colors of the Macbeth color chart, the spectral sensitivity characteristic data of the color filter of the camera obtained from the database or the camera, and the spectral distribution characteristic data of the imaging light source obtained from the image capturing side external sensor 801.

The accuracy evaluation XYZ value acquisition unit 108 calculates, based on the color-matching function, XYZ values that are obtained when the color chart composed of the 24 sample colors of the Macbeth color chart is observed in the observation environment based on the spectral reflectance data of each of the 24 sample colors of the Macbeth color chart and the spectral distribution characteristic data of the observation light source obtained from the observation side external sensor 802.

The conversion unit 109 converts the accuracy evaluation RGB values acquired by the accuracy evaluation RGB value acquisition unit 107 into XYZ values by using the conversion coefficients calculated by the conversion information calculation unit 105.

The error calculation unit 110 compares the XYZ values obtained after the conversion by the conversion unit 109 with the accuracy evaluation XYZ values acquired by the accuracy evaluation XYZ value acquisition unit 108 and calculates an error in the conversion coefficients calculated by the conversion information calculation unit 105.

The error calculated by the error calculation unit 110 is fed back to the selection unit 102. Next, the selection unit 102 selects 9 sample colors from among the 24 colors included in the Macbeth color chart by using an optimization algorithm such that the error in the conversion coefficients is minimized.

In the method for obtaining RGB values by calculation (or the configuration of the information processing apparatus 100 illustrated in FIG. 8) described in Section F-2, since the spectral characteristics of all the equipment are known, it is possible to select optimal 9 colors for the combination of the environment and the equipment. Thus, compared to the method for acquiring the RGB values by actually performing image capturing described above in Section F-1, further optimized conversion coefficients can be calculated, that is, further optimized correction can be performed on the subject image.

In addition, in the configuration of the information processing apparatus 100 illustrated in FIG. 8, since the spectral distribution characteristics of each of the imaging light source and the observation light source can be dynamically obtained, it is possible to update the conversion coefficients while adapting to environmental changes by regularly updating the 9 colors in the selection unit 102 so that further optimized correction can be performed on the optimal subject image. For example, while adapting to environmental changes such as changes from the daytime to early evening and then to the nighttime, further optimized correction can be performed on the optimal subject image.

### F-3. Implementation Examples

In the method for obtaining RGB values by calculation described above in Section F-2, in order to dynamically select 9 colors from the 24 colors of the Macbeth color chart, the calculation for obtaining conversion coefficients needs to be performed on a computing machine. The calculation load needed to perform this calculation in a cycle of several seconds to several minutes is light. Thus, the conversion coefficients can be obtained by using a central processing unit (CPU) mounted on the equipment such as a camera or a display device without using a dedicated computer (for example, a PC or a cloud server).

In Section F-3, implementation examples in which each of the components of the information processing apparatus 100 illustrated in FIG. 8 is arranged in a server, a camera (or the image capturing side), or a display device (or the observation side).

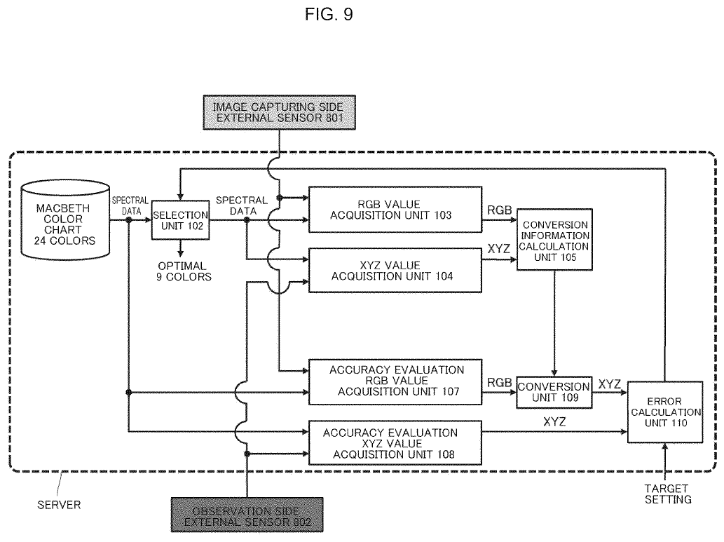

FIG. 9 illustrates an implementation example in which most of the components of the information processing apparatus 100 illustrated in FIG. 8 are realized by a server (for example, a cloud server). In FIG. 9, the component implemented on the image capturing side or in the camera is indicated by being filled with light gray, and the component implemented on the observation side or in the display device is indicated by being filled with dark gray. The components included in a range surrounded by a dashed line in FIG. 9 are implemented on the server. This server calculates RGB values that are obtained when the camera captures an image of the color chart by using the spectral distribution characteristics of the imaging light source supplied from the image capturing side external sensor 801 and the spectral distribution characteristics of the observation light source supplied from the observation side external sensor 802 and selects a further optimized combination of sample colors so that highly accurate conversion coefficients can be calculated.

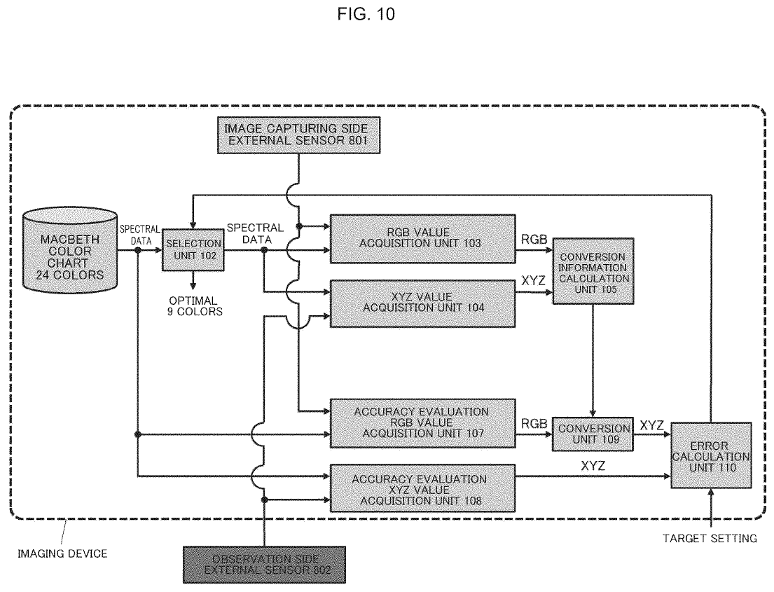

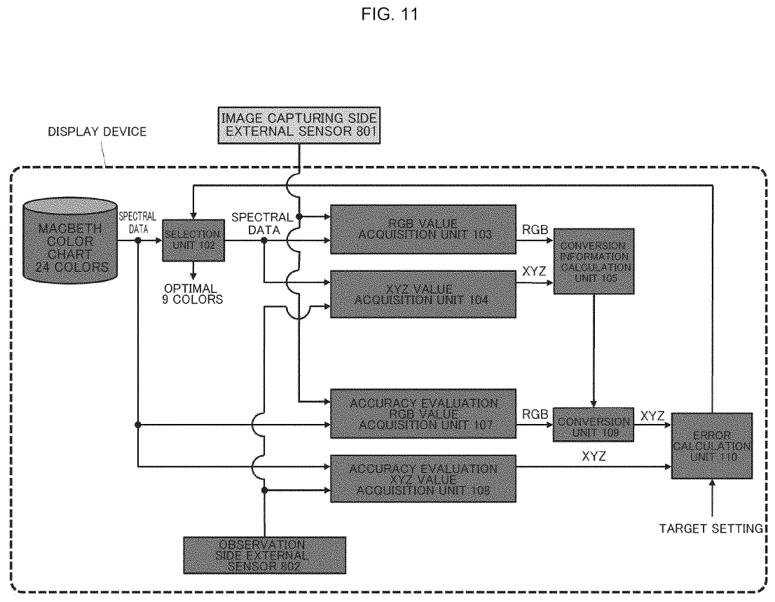

FIG. 10 illustrates an implementation example in which most of the components of the information processing apparatus 100 illustrated in FIG. 8 are realized by a camera. In FIG. 10, the components implemented on the image capturing side or in the camera are indicated by being filled with light gray, and the component implemented on the observation side or in the display device is indicated by being filled with dark gray. This camera internally obtains the spectral distribution characteristics of the imaging light source, calculates RGB values that are obtained when the camera captures an image of the color chart by using the spectral distribution characteristics of the observation light source supplied from the observation side external sensor 802, and selects a further optimized combination of sample colors so that highly accurate conversion coefficients can be calculated. Therefore, this camera can output an XYZ image while capturing an RGB image.

FIG. 11 illustrates an implementation example in which most of the components of the information processing apparatus 100 illustrated in FIG. 8 are realized by a display device. In FIG. 11, the component implemented on the image capturing side or in the camera is indicated by being filled with light gray, and the components implemented on the observation side or in the display device are indicated by being filled with dark gray. This display device internally obtains the spectral distribution characteristics of observation light source, calculates RGB values that are obtained when the camera captures an image of the color chart by using the spectral distribution characteristics of the imaging light source supplied from the image capturing side external sensor 801, and selects a further optimized combination of sample colors so that highly accurate conversion coefficients can be calculated. Therefore, this display device can convert the RGB image supplied from the camera into an XYZ image, reproduce the correct color, and display.

### F-4. Functional Configuration of Camera

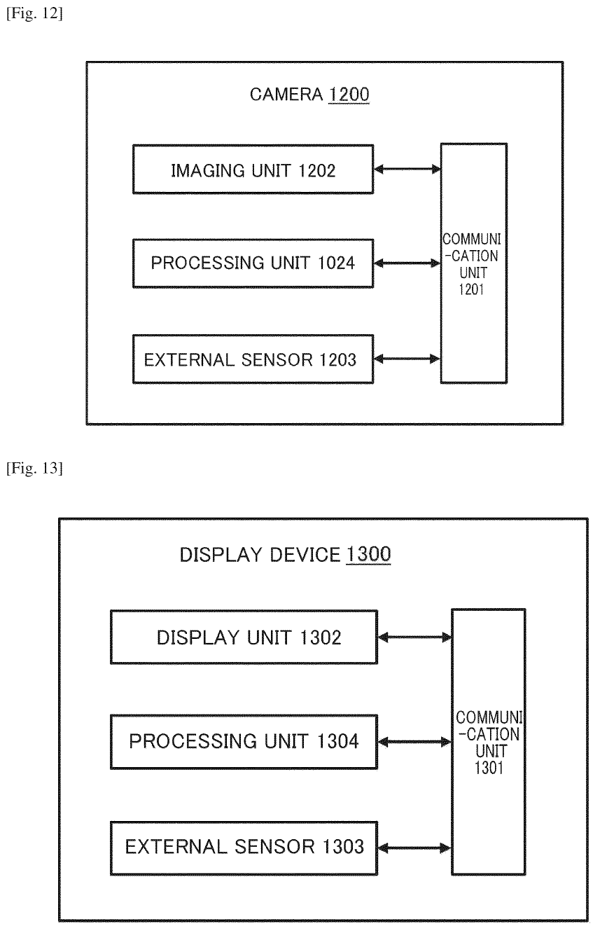

FIG. 12 illustrates an example of a functional configuration of a camera 1200 applicable to the present disclosure. The camera 1200 can supply the spectral distribution characteristic data of the imaging light source to the RGB value acquisition unit 103 and the accuracy evaluation RGB value acquisition unit 107. The camera 1200 includes a communication unit 1201, an imaging unit 1202, an external light sensor 1203, and a processing unit 1204.

The communication unit 1201 is a wired or wireless communication interface that communicates with an external device via a network. The external device referred to here is, for example, a conversion device that converts RGB values output from the camera 1200 into XYZ values, the information processing apparatus 100 (see FIG. 8) that calculates conversion information for converting RGB values output from the camera 1200 into XYZ values, or the like. The communication interface supports wireless communication such as Wi-Fi (registered trademark) or Bluetooth (registered trademark), or wired communication such as Ethernet (registered trademark), Universal Serial Bus (USB), or High Definition Multimedia Interface (HDMI (registered trademark)). The communication unit 1201 is used, for example, to transmit an image captured by the imaging unit 1202 and sensor data sensed by the external light sensor 1203 to the external device.

The imaging unit 1202 includes an optical lens that collects reflected light from a subject and an image sensor that includes a complementary metal oxide semiconductor (CMOS) and captures a moving image or a still image of the subject to generate a captured image (RGB values). The imaging unit 1202 outputs the captured image to the conversion device or the information processing apparatus 100 via the communication unit 1201.

The external light sensor 1203 is a device that obtains information about the imaging light source installed in the image capturing environment. The external light sensor 1203 includes, for example, a plurality of color sensors (not illustrated). The individual color sensors separate and extract light having different wavelengths (color components). Thus, the external light sensor 1203 performs filter spectral processing for separating, for example, light in a visible spectrum (wavelengths from 380 nm to 780 nm) to the human eye into a plurality of color components having respective wavelengths by using the plurality of color sensors and separates and extracts light of a predetermined wavelength. The external light sensor 1203 corresponds to the image capturing side external sensor 801 that supplies the spectral distribution characteristic data of the imaging light source to the RGB value acquisition unit 103 and the accuracy evaluation RGB value acquisition unit 107 in FIG. 8 and outputs the separation results of radiation light emitted from the imaging light source to the information processing apparatus 100 via the communication unit 1201, for example.

Although the configuration example in which the external light sensor 1203 performs the spectral processing by using a plurality of color sensors has been described above, the configuration of the external light sensor 1203 is not limited thereto. The external light sensor 1203 may be a sensor, such as a spectrometer, that acquires the spectrum of the light source more specifically. By using a spectrometer as the external light sensor 1203, the processing for estimating the light source can be omitted on the information processing apparatus 100 side. However, considering that spectrometers are expensive and not commonly used, the external light sensor 1203 can be configured more inexpensively and easily by using a plurality of color sensors as described above.

The processing unit 1204 includes, for example, a CPU, and performs corresponding processing on each component included in, for example, the range surrounded by the dashed line in the implementation example illustrated in FIG. 10.

### F-5. Functional Configuration of Display Device

FIG. 13 illustrates an example of a functional configuration of a display device 1300 applicable to the present disclosure. The display device 1300 can supply the spectral distribution characteristic data of the observation light source to the XYZ value acquisition unit 104 and the accuracy evaluation XYZ value acquisition unit 108. The display device 1300 includes a communication unit 1301, a display unit 1302, an external light sensor 1303, and a processing unit 1304.

The communication unit 1301 is a wired or wireless communication interface that communicates with an external device via a network. The external device referred to here is, for example, a conversion device that converts RGB values output from the camera 1200 into XYZ values, the information processing apparatus 100 (see FIG. 8) that calculates conversion information, or the like. The communication interface supports wireless communication such as Wi-Fi (registered trademark) or Bluetooth (registered trademark), or wired communication such as Ethernet (registered trademark), USB, or HDMI (registered trademark). The communication unit 1301 is used, for example, to receive an image to be output and displayed on the display unit 1302 from the external device and to transmit sensor data sensed by the external light sensor 1303 to the external device.

The display unit 1302 is, for example, a liquid crystal display (LCD), an organic electro luminescence (EL) display, or the like and displays an image received from the external device via the communication unit 1301. The display unit 1302 may convert a conversion image of the XYZ values from the conversion device into an image of RGB values to be displayed.

The external light sensor 1303 is a device that obtains information about the observation light source installed in the observation environment. The external light sensor 1303 includes, for example, a plurality of color sensors (not illustrated). The individual color sensors separate and extract light having different wavelengths (color components). Therefore, the external light sensor 1303 performs filter spectral processing for separating, for example, light in a visible spectrum (wavelengths from 380 nm to 780 nm) to the human eye into a plurality of components for respective wavelengths by using a plurality of color sensors and separates and extracts light of a predetermined wavelength. The external light sensor 1303 corresponds to the observation side external sensor 802 that supplies the spectral distribution characteristic data of the observation light source to the XYZ value acquisition unit 104 and the accuracy evaluation XYZ value acquisition unit 108 in FIG. 8 and outputs the separation result of radiation light emitted from the observation light source to the information processing apparatus 100 via the communication unit 1301, for example. Note that the external light sensor 1303 is not limited to the configuration in which the spectral processing is performed by using a plurality of color sensors and may be a sensor, such as a spectrometer, that acquires the spectrum of the light source more specifically (the same as described above).

The processing unit 1304 includes, for example, a CPU, and performs corresponding processing on each component included in, for example, the range surrounded by the dashed line in the implementation example illustrated in FIG. 11.

### G. Theoretical Calculation of Error

An error in the conversion coefficients calculated by using the optimal 9 colors selected from the 24 colors of the Macbeth color chart in accordance with the present disclosure was theoretically calculated and compared with an error in the conversion coefficients calculated by using 9 colors empirically selected from the 24 colors of the Macbeth color chart and an error in the conversion coefficients calculated by using all the 24 colors of the Macbeth color chart.

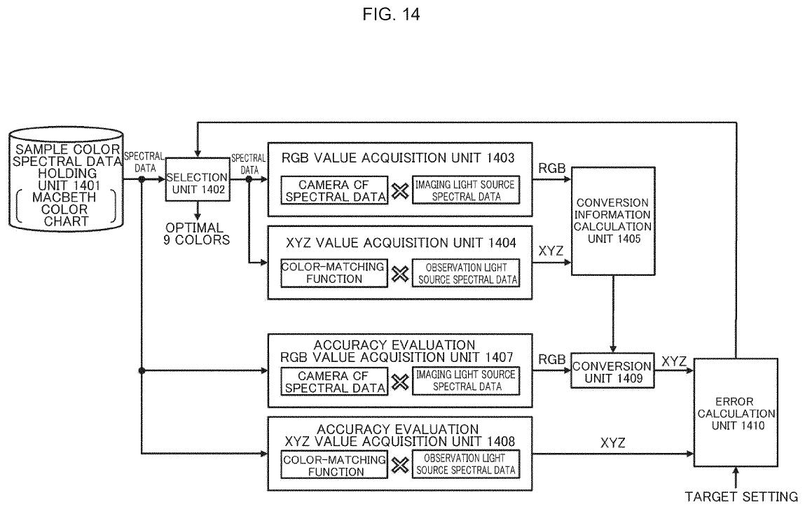

FIG. 14 illustrates a functional configuration for theoretically calculating an error in the conversion coefficients calculated by using 9 colors selected from the 24 colors of the Macbeth color chart based on the present disclosure. FIG. 14 has basically the same functional configuration as that of FIG. 1. However, FIG. 14 differs from FIG. 1 in that the same Macbeth color chart is used when the conversion coefficients are calculated and when the accuracy evaluation is performed.

A selection unit 1402 selects 9 sample colors from among the 24 colors included in the Macbeth color chart, reads the spectral reflectance data of each of the selected sample colors from a sample color spectral data holding unit 1401, and outputs the read spectral reflectance data to the functional block in the subsequent stage.

An RGB value acquisition unit 1403 calculates RGB values that are obtained when a camera captures an image of a color chart composed of the 9 sample colors based on the spectral reflectance data of each of the 9 sample colors selected by the selection unit 1402, the spectral sensitivity characteristic data of a color filter of the camera, and the spectral distribution characteristic data of an imaging light source.

An XYZ value acquisition unit 1404 calculates, based on a color-matching function, XYZ values that are obtained when the color chart composed of the 9 sample colors selected by the selection unit 1402 is observed in an observation environment based on the spectral reflectance data of each of the 9 sample colors selected by the selection unit 1402 and the spectral distribution characteristic data of an observation light source.

A conversion information calculation unit 1405 compares the camera-output RGB values acquired by the RGB value acquisition unit 1403 with the XYZ values acquired by the XYZ value acquisition unit 1404 and calculates conversion coefficients for converting the RGB values into XYZ values by using a least squares method or the like.

An accuracy evaluation RGB value acquisition unit 1407 calculates RGB values that are obtained when the camera captures an image of a color chart composed of the 24 sample colors of the Macbeth color chart based on the spectral reflectance data of the 24 sample colors of the Macbeth color chart, the spectral sensitivity characteristic data of the color filter of the camera, and the spectral distribution characteristic data of the imaging light source.

An accuracy evaluation XYZ value acquisition unit 1408 calculates, based on the color-matching function, XYZ values that are obtained when the color chart composed of the 24 sample colors of the Macbeth color chart is observed in the observation environment based on the spectral reflectance data of each of the 24 sample colors of the Macbeth color chart and the spectral distribution characteristic data of the observation light source.

A conversion unit 1409 converts the accuracy evaluation RGB values acquired by the accuracy evaluation RGB value acquisition unit 1407 into XYZ values by using the conversion coefficients calculated by the conversion information calculation unit 1405.

An error calculation unit 1410 compares the XYZ values into which the RGB values are converted by the conversion unit 1409 using the conversion coefficients with the accuracy evaluation XYZ values acquired by the accuracy evaluation XYZ value acquisition unit 1408 and calculates an error in the conversion coefficients calculated by the conversion information calculation unit 1405 based on a set target. The error calculation unit 1410 sets the target of error calculation based on the target of color reproduction or the application field of the conversion information. Setting the target enables processing such as increasing accuracy of a specific sample color in accordance with a target application field.

The error calculated by the error calculation unit 1410 is fed back to the selection unit 1402. Next, the selection unit 1402 selects 9 sample colors from among the 24 colors included in the Macbeth color chart by using an optimization algorithm such that the error in the conversion coefficients is minimized. In this way, the error calculated by using the optimized 9 sample colors can be obtained.

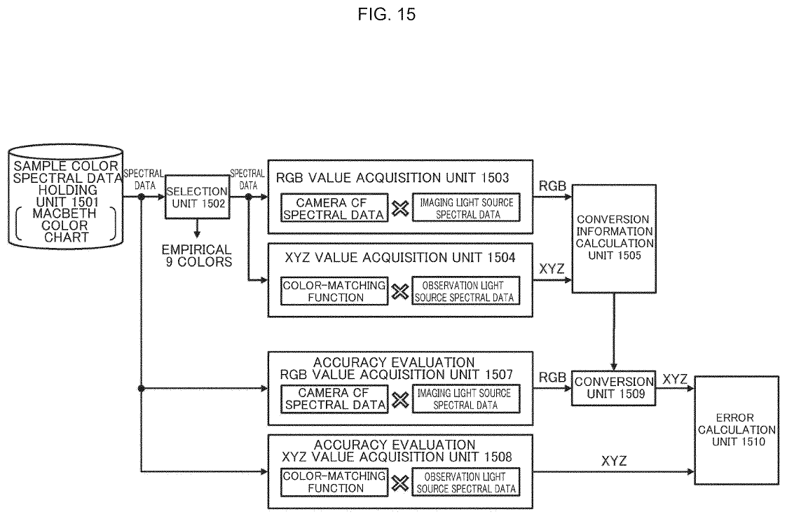

FIG. 15 illustrates, as a comparison to FIG. 14, a functional configuration for theoretically calculating an error in the conversion coefficients calculated by using 9 colors empirically selected from the 24 colors of the Macbeth color chart. The functional configuration illustrated in FIG. 15 differs from that in FIG. 14 in that a target is not set when an error in the conversion coefficients is calculated and that the calculated error is not fed back, and the rest is the same as in FIG. 14.

A selection unit 1502 empirically selects 9 sample colors from among the 24 colors included in the Macbeth color chart, reads the spectral reflectance data of each of the selected sample colors from a sample color spectral data holding unit 1501, and outputs the read spectral reflectance data to the functional block in the subsequent stage.

An RGB value acquisition unit 1503 calculates RGB values that are obtained when the camera captures an image of empirically selected 9 sample colors. An XYZ value acquisition unit 1504 calculates XYZ values that are obtained when the empirically selected 9 sample colors are observed in the observation environment based on the color-matching function. Next, a conversion information calculation unit 1505 calculates conversion coefficients for converting the camera-output RGB values acquired by the RGB value acquisition unit 1503 into the XYZ values acquired by the XYZ value acquisition unit 1504 by using the least squares method or the like.

An accuracy evaluation RGB value acquisition unit 1507 calculates RGB values that are obtained when the camera captures an image of the 24 colors of the Macbeth color chart. An accuracy evaluation XYZ value acquisition unit 1508 calculates XYZ values that are obtained when the 24 colors of the Macbeth color chart are observed in the observation environment based on the color-matching function. A conversion unit 1509 converts the accuracy evaluation RGB values acquired by the accuracy evaluation RGB value acquisition unit 1507 into XYZ values by using the conversion coefficients calculated by the conversion information calculation unit 1505. Next, an error calculation unit 1510 compares the XYZ values obtained after the conversion by the conversion unit 1509 with the accuracy evaluation XYZ values acquired by the accuracy evaluation XYZ value acquisition unit 1508 and calculates an error in the conversion coefficients calculated by the conversion information calculation unit 1505. However, since the 9 colors are empirically selected from the source 24 colors, target setting is not performed when an error is calculated. In this way, the error calculated by using the empirically selected 9 sample colors can be obtained.

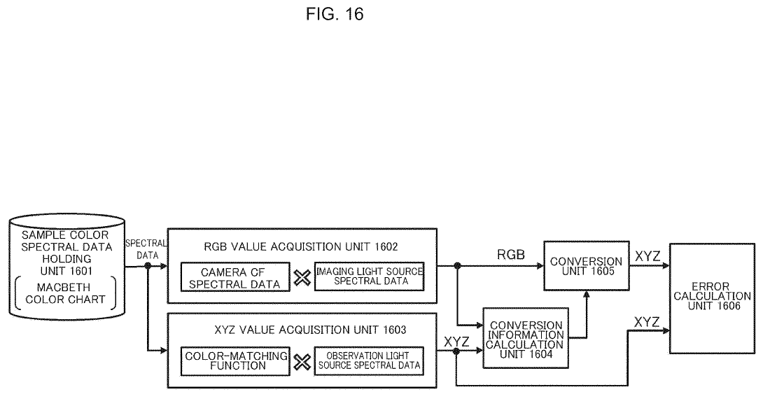

As a further comparison to FIG. 14, FIG. 16 illustrates a functional configuration for theoretically calculating an error in the conversion coefficients calculated by using the 24 colors of the Macbeth color chart. Since all the source sample colors are used for the calculation of conversion coefficients, a selection unit for selecting some of the sample colors is not included.

An RGB value acquisition unit 1602 calculates RGB values that are obtained when the camera captures an image of a color chart composed of sample colors of 24 colors of the Macbeth color chart, based on the spectral reflectance data of each sample color of the 24 colors of the Macbeth color chart read from a sample color spectral data holding unit 1601, the spectral sensitivity characteristic data of the color filter of the camera, and the spectral distribution characteristic data of the imaging light source.

An XYZ value acquisition unit 1603 calculates, based on the color-matching function, XYZ values that are obtained when the color chart composed of the 24 sample colors of the Macbeth color chart is observed in the observation environment based on the spectral reflectance data of each of the 24 sample colors of the Macbeth color chart and the spectral distribution characteristic data of the observation light source.

A conversion information calculation unit 1604 compares the camera-output RGB values acquired by the RGB value acquisition unit 1602 with the XYZ values acquired by the XYZ value acquisition unit 1603 and calculates conversion coefficients for converting the RGB values into the XYZ values by using the least squares method or the like.

A conversion unit 1605 converts the RGB values acquired by the RGB value acquisition unit 1602 into XYZ values by using the conversion coefficients calculated by the conversion information calculation unit 1604.

An error calculation unit 1606 compares the XYZ values into which the RGB values are converted by the conversion unit 1605 using the conversion coefficients with the XYZ values acquired by the XYZ value acquisition unit 1603 and calculates an error in the conversion coefficients calculated by the conversion information calculation unit 1604.

Note that, in the configuration examples illustrated in FIGS. 14 to 16, too, four types of light sources, which are D65, a white LED, a high color rendering white LED, and a fluorescent light, are used as the imaging light source, all the observation light sources are D65, and all the cameras have an RGB single plate.

Next, the sample colors used in each of FIGS. 14 to 16 will be described.

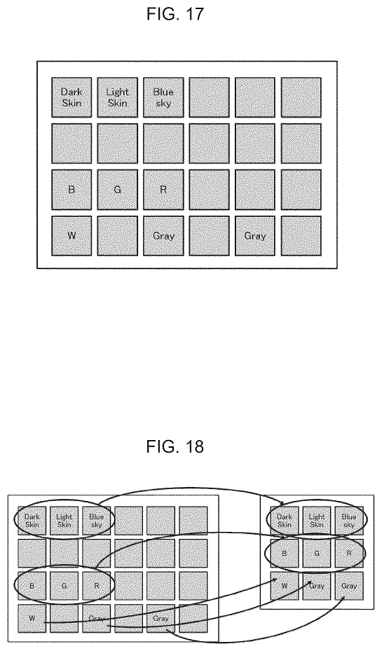

FIG. 17 illustrates a Macbeth color chart. In the Macbeth color chart, 24 sample colors are arranged in a 4×6 matrix from the upper left to the lower right. A unique name, such as “dark skin”, “light skin”, “blue sky”, etc., is assigned to each sample color, and spectral reflectance is defined for each sample color.

FIG. 18 illustrates an example of 9 colors empirically selected from the 24 colors of the Macbeth color chart. In FIG. 18, for the purpose of reproducing a skin color, two types of skin color, blue sky with low saturation, three primary colors of BGR, and three colors of white and gray are empirically selected from among the source 24 colors.

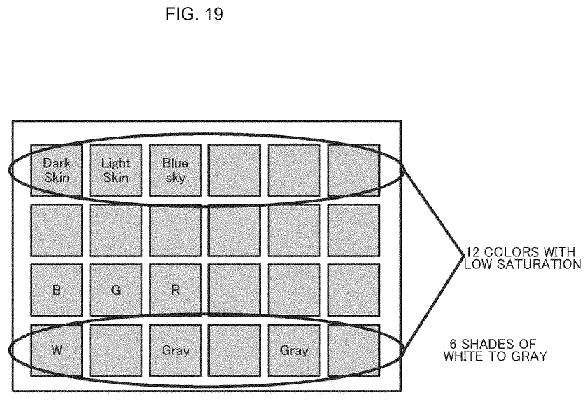

FIG. 19 illustrates an example in which a target is set for each color for a calculated color difference in the method illustrated in FIG. 2 in which the camera output XYZ values and the observed XYZ values are converted into two-dimensional xy coordinates and compared. Specifically, delta-x and delta-y standard deviations with low saturation and the coordinate movement distances of six shades of white to gray are calculated from among the 24 evaluation colors of the Macbeth color chart, and the target is set to minimize the sum of these two. Two skin colors are included in the 12 low-saturation colors, and the skin color having the smaller standard deviation of these two is more likely to have higher reproducibility of the skin.

The present inventor compared the errors (error standard deviation and coordinate movement distance) calculated by using the assumed imaging light sources (D65, white LED, high color rendering white LED, fluorescent light) for each of the cases where all the 24 colors of the Macbeth color chart were used (all 24 colors: see FIG. 16), where 9 colors empirically selected from the 24 colors were used (empirical 9 colors: see FIG. 15), and where optimal 9 colors were selected form the 24 colors (optimal 9 colors: see FIG. 14). However, the error calculation was performed by using the same color chart regardless of the imaging light source for the all 24 colors and the empirical 9 colors, and the error calculation was performed by using a color chart of 9 colors optimized for each imaging light source for the optimal 9 colors, and the obtained calculation results were compared.

As a result, it was confirmed that the accuracy of the conversion coefficients theoretically calculated by using the color chart composed of the 9 colors optimized with the set target was higher (had a smaller error) than the accuracy of the conversion coefficients theoretically calculated by using the color chart of the empirical 9 colors and was also higher than the accuracy of the conversion coefficients theoretically calculated by using the color chart of the all 24 colors in some cases. When the equipment (camera, light source) is determined, the accuracy of the conversion coefficients can be further improved by using the color chart composed of the combination of colors optimized based on the present disclosure. Note that the optimal combination of 9 colors selected based on the present disclosure is completely different from the combination of 9 colors empirically selected, and the optimal combination of 9 colors differs for each imaging light source.

### H. Processing Flow

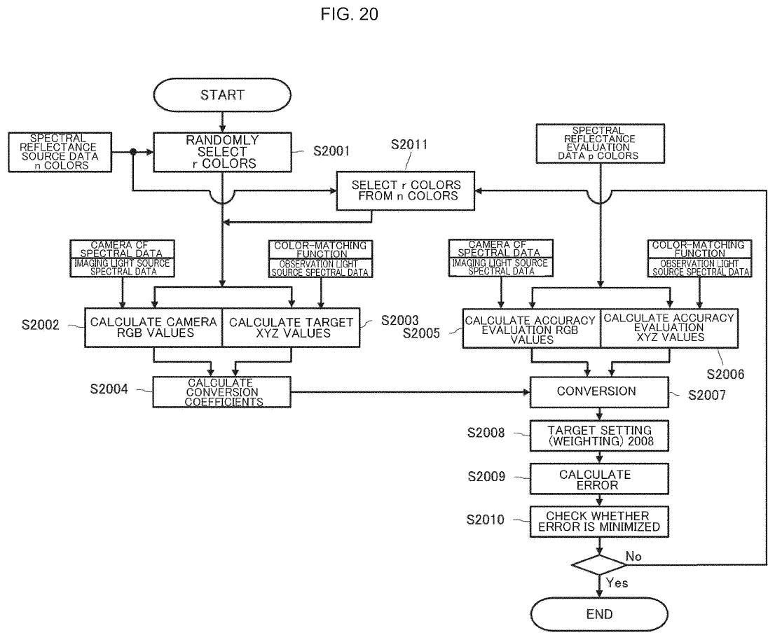

FIG. 20 illustrates, in the form of a flowchart, a processing procedure for selecting an optimal combination of r sample colors used for a color chart for calculating conversion coefficients from among n sample colors each having known spectral reflectance characteristics in the information processing apparatus 100 illustrated in FIG. 1. Hereinafter, the processing for selecting an optimal combination of sample colors on the information processing apparatus 100 will be described with reference to the flowchart illustrated in FIG. 20.

First, the selection unit 102 randomly selects r colors from among n sample colors serving as a selection source (step S2001), reads the spectral reflectance data of each selected sample color from the sample color spectral data holding unit 101, and outputs the read spectral reflectance data to the functional block in the subsequent stage.

The RGB value acquisition unit 103 obtains, by calculation, RGB values (camera RGB values) that are obtained when a camera captures an image of a color chart composed of these r colors based on the spectral reflectance data of each of the r sample colors selected by the selection unit 102, the spectral sensitivity characteristic data of a color filter of the camera, and the spectral distribution characteristic data of an imaging light source (step S2002).

The XYZ value acquisition unit 104 calculates, based on a color matching function, XYZ values as target values (target XYZ values) based on the spectral reflectance data of each of the r sample colors selected by the selection unit 102 and the spectral distribution characteristic data of a light source (observation light source) in an observation environment (step S2003).

Next, the conversion information calculation unit 105 compares the camera-output RGB values acquired by the RGB value acquisition unit 103 with the XYZ values acquired by the XYZ value acquisition unit 104 and calculates conversion coefficients for converting the RGB values into the XYZ values by using a least squares method or the like (step S2004).

The accuracy evaluation RGB value acquisition unit 107 reads the spectral reflectance data of each of p sample colors for accuracy evaluation from the accuracy evaluation sample color spectral data holding unit 106 and calculates accuracy evaluation RGB values that are obtained when the camera captures an image of a color chart composed of these p colors in the image capturing environment based on the spectral sensitivity characteristic data of the color filter of the camera and the spectral distribution characteristic data of the imaging light source (step S2005).

The accuracy evaluation XYZ value acquisition unit 108 calculates, based on the color-matching function, XYZ values as target values for accuracy evaluation based on the spectral reflectance data of each of these p sample colors and the spectral distribution characteristic data of the light source (observation light source) in the observation environment (step S2006).

Next, the conversion unit 109 converts the accuracy evaluation RGB values acquired by the accuracy evaluation RGB value acquisition unit 107 into XYZ values by using the conversion coefficients calculated by the conversion information calculation unit 105 (step S2007). Alternatively, in step S2007, the conversion unit 109 may convert the accuracy evaluation XYZ values acquired by the accuracy evaluation XYZ value acquisition unit 108 into RGB values by using the conversion coefficients calculated by the conversion information calculation unit 105.

When the error calculation unit 110 obtains color differences between the RGB values or between the XYZ values obtained in steps S2005 to S2007, the error calculation unit 110 assigns weights to each color difference for each color in accordance with the set target (step S2008) and calculates an error (standard error or the like) in the conversion coefficients obtained in step S2004 (step S2009).

Next, the error calculation unit 110 checks whether the calculated error has been minimized (step S2010). When it is determined that the error in the conversion coefficients has been minimized (Yes in step S2010), the information processing apparatus 100 outputs the conversion coefficients to an external device (for example, a conversion device that performs processing for converting the RGB values of the image captured by the camera into XYZ values) and ends the present processing.

When it is determined that the error in the conversion coefficients has not yet been minimized (No in step S2010), the error calculation unit 110 feeds back the calculation result to the selection unit 102. The selection unit 102 then selects r sample colors from among the n colors again by using the optimization algorithm such that the error in the conversion coefficients is minimized (step S2011), and the same processing as described above is repeatedly performed.

According to the processing procedure illustrated in FIG. 20, an optimal combination of r sample colors can be selected in accordance with the equipment (camera, light source) and the target, and therefore, highly accurate conversion coefficients for each equipment and target can be calculated.

### I. Effects

For example, PTL 1 discloses a technique in which, when an image captured by a camera is observed at a remote location, RGB values of the captured image of a subject are converted into XYZ values so as to reproduce the image in colors observed on the observation side. Whereas, the information processing apparatus 100 according to the present disclosure can select an optimal combination of sample colors as a color chart to be used when the conversion coefficients for converting the RGB values into the XYZ values are calculated.

As described above in Section F, there are the method (F-1) for calculating conversion coefficients and an error thereof by using RGB values that are obtained by actually capturing an image of a printed color chart by a camera and the method (F-2) for calculating RGB values that are obtained when a camera captures and outputs an image of a color chart based on the spectral reflectance characteristics of each sample color held as data, the spectral sensitivity characteristics of the color filter of the camera, and the spectral distribution characteristics of the imaging light source without printing the color chart.

When the method (F-1) is adopted, the sample colors need to be selected in advance in order to print the color chart. However, according to the present disclosure, there is an effect that the printing cost can be reduced by reducing the number of colors of the color chart. In addition, when the equipment to be used and the color reproduction target are determined, an optimal color chart can be provided by selecting an optimal combination of sample colors with a smaller number of colors. The use of the optimal color chart can improve the accuracy of the conversion coefficients, in other words, improve the accuracy of color reproduction. On the other hand, when the equipment to be used is not determined, the equipment is assumed, and by performing weighting or the like, further optimized combination of sample colors can be selected. The method for selecting the sample colors can be realized by either the actual equipment (camera or display device) or a computing machine other than the actual equipment.

When the method (F-2) is adopted, since the color chart is not printed but is held as the spectral reflectance characteristic data of each sample color and the equipment (camera, light source) is already determined (that is, the spectral characteristics of each piece of equipment is known), an optimal combination of sample colors can be dynamically selected in accordance with the environment and the target. Therefore, the use of the optimal color chart can improve the accuracy of the conversion coefficients, in other words, improve the accuracy of the color reproduction. The method for selecting the sample colors can be realized on a computing machine.

In addition, in both the methods (F-1) and (F-2), by setting a target of color reproduction and performing error calculation in accordance with the target, it is possible to control to increase the accuracy of color reproduction in a specific color.

### J. Hardware Configuration of Information Processing Apparatus

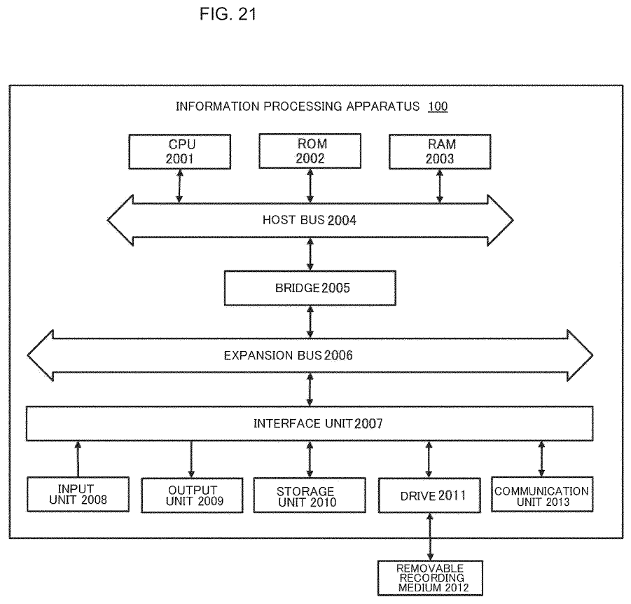

FIG. 21 illustrates an example of a hardware configuration of the information processing apparatus 100 capable of realizing the functional configuration illustrated in FIG. 1. The illustrated information processing apparatus 100 includes a CPU 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 functions as an arithmetic processing unit and a control unit and controls the overall operation of the information processing apparatus 100 in accordance with various programs. The ROM 2002 stores programs (such as a basic input/output system) and operation parameters used by the CPU 2001 in a nonvolatile manner. The RAM 2003 is used to load a program to be used in the execution of the CPU 2001 and to temporarily store parameters such as work date that appropriately changes in the execution of the program. The programs loaded into the RAM 2003 and executed by the CPU 2001 are, for example, various application programs and an operating system (OS).

The CPU 2001, the ROM 2002, and the RAM 2003 are connected to each other by the host bus 2004, which is configured by a CPU bus or the like. The CPU 2001 can realize various functions and services by executing various application programs in the execution environment provided by the OS through cooperative operations of the ROM 2002 and the RAM 2003. When the information processing apparatus 100 is a personal computer, the OS is, for example, Windows by Microsoft Corporation or Unix. When the information processing apparatus 100 is an information terminal such as a smartphone or a tablet, the OS is, for example, iOS by Apple Inc. or Android by Google Inc. The application programs include an application for executing the processing procedure illustrated in FIG. 20 or an application for operating the information processing apparatus 100 as each functional block in FIG. 1.

The host bus 2004 is connected to the expansion bus 2006 via the bridge 2005. The expansion bus 2006 is, for example, a Peripheral Component Interconnect (PCI) bus or PCI Express, and the bridge 2005 is based on the PCI standard. However, the information processing apparatus 100 does not need to have a configuration in which the circuit components are separated by the host bus 2004, the bridge 2005, and the expansion bus 2006 and may have a configuration in which almost all the circuit components are mutually connected by a single bus (not illustrated).

The interface unit 2007 connects peripheral devices such as the input unit 2008, the output unit 2009, the storage unit 2010, the drive 2011, and the communication unit 2013 in accordance with the standard of the expansion bus 2006. However, all the peripheral devices illustrated in FIG. 21 are not necessarily indispensable, and the information processing apparatus 100 may further include a peripheral device not illustrated. Furthermore, the peripheral devices may be incorporated in the main body of the information processing apparatus 100, or some of the peripheral devices may be externally connected to the main body of the information processing apparatus 100.

The input unit 2008 includes an input control circuit or the like that generates an input signal based on an input from a user and outputs the input signal to the CPU 2001. When the information processing apparatus 100 is a personal computer, the input unit 2008 may include a keyboard, a mouse, and a touch panel and may further include a camera and a microphone. When the information processing apparatus 100 is an information terminal such as a smartphone or a tablet, the input unit 2008 is, for example, a touch panel, a camera, or a microphone and may further include other mechanical operators

The output unit 2009 includes an audio output device such as a speaker and headphones. The output unit 2009 includes, for example, a display device such as an LCD, an organic EL display, and a light-emitting diode (LED).

The storage unit 2010 stores files such as programs (applications, the OS, etc.) executed by the CPU 2001 and various types of data. The data stored in the storage unit 2010 may include a corpus of normal speech and whisper (described above) for training the neural network. The storage unit 2010 includes, for example, a mass storage device such as a solid state drive (SSD) or a hard disk drive (HDD) and may include an external storage device.

A removable storage medium 2012 is a cartridge-type storage medium, such as a microSD card. The drive 2011 performs read and write operations on the loaded removable storage medium 2012. The drive 2011 outputs the date read from the removable recording media 2012 to the RAM 2003 or the storage unit 2010 and writes the date on the RAM 2003 or the storage unit 2010 onto the removable recording media 2012.

The communication unit 2013 is a device that performs wireless communication such as Wi-Fi (registered trademark), Bluetooth (registered trademark), or cellular communication networks such as 4G and 5G. The communication unit 2013 includes a terminal such as a USB terminal or an HDMI (registered trademark) terminal and may further include a function of performing HDMI (registered trademark) communication with a USB device such as a scanner or a printer, a display, or the like.

Although a PC is assumed as the information processing apparatus 100, the number of PCs is not limited to one, and two or more PCs may be configured to realize the information processing apparatus 100 illustrated in FIG. 1 in a distributed manner or execute various applications for selecting optimal colors in accordance with a set target or calculating conversion coefficients by using a color chart composed of optimally selected colors.

By executing a predetermined program code, the information processing apparatus 100 illustrated in FIG. 21 can realize the functional configuration illustrated in FIG. 1 and can also perform the processing procedure illustrated in FIG. 20, that is, the information processing apparatus 100 can select an optimal combination of colors as a color chart in accordance with a set target, generate highly accurate conversion information based on the optimal color chart, and provide the conversion information to the conversion device.

### INDUSTRIAL APPLICABILITY

The present disclosure has thus been described in detail with reference to the specific embodiment. However, the present disclosure should not be interpreted as being limited to the above-described embodiment, and it is obvious that those skilled in the art can make modifications and substitutions of the embodiment without departing from the gist of the present disclosure. In addition, the effects described in the present description are merely examples. Thus, the effects brought by the present disclosure are not limited thereto, and there may be additional effects not described in the present description.

Although the present disclosure has been described herein with a focus on the specific embodiment, the scope of the present disclosure is not limited thereto.

The present disclosure is applicable, for example, to the field of telemedicine. In that case, the present disclosure is applicable to a situation where an image of a patient captured in a hospital A is displayed on a monitor in another hospital B for a doctor to examine, and by reproducing the facial color of the patient displayed on the monitor in the same color as in the case where the doctor would observe in the hospital B, the doctor can remotely examine the patient in the hospital A as if the patient were in the hospital B. In addition, the present disclosure is applicable to a situation where a work robot is remotely operated at a difficult work site such as a construction site, a nuclear power plant, or outer space, and an operator can give an instruction (for example, remotely operate a robot) while observing a site image that is reproduced with high accuracy.

In addition, the application range of the present disclosure is not limited to the case where the image capturing environment and the observation environment are physically far apart from each other and can include various scenes where the color of a subject in the image capturing environment cannot be accurately reproduced in the observation environment.

In short, it should be understood that the present disclosure has been described as an example, and the contents of the present description should not be construed as being limited thereto. The gist of the present disclosure should be determined with reference to the claims.

A series of processes described in the present description may be performed by hardware, software, or a combination of hardware and software. When the processing is performed by software, a program in which the processing sequence related to implementation of the present disclosure is recorded is installed in a memory incorporated in dedicated hardware in a computer and executed. It is also possible to install a program in a general-purpose computer capable of performing various kinds of processing and cause the computer to perform the processing related to implementation of the present disclosure.

The program can be stored in advance in a recording medium provided in the computer, such as an HDD, an SSD, or a ROM as a recording medium.

Alternatively, the program can be temporarily or permanently stored in a removable recording medium such as a flexible disk, a compact disc read-only memory (CD-ROM), a magneto optical (MO) disc, a digital versatile disc (DVD), a Blu-ray disc (BD) (registered trademark), a magnetic disk, or a universal serial bus (USB) memory. By using such a removable recording medium, a program related to implementation of the present disclosure can be provided as so-called package software.

In addition, the program may be transferred from a download site to the computer using wireless or wired communication via a network such as a wide area network (WAN) represented by a cellular network, a local area network (LAN), or the Internet. The computer can receive the program transferred in such a manner and install the program in a mass storage device such as an HDD or an SSD in the computer.

The present disclosure may have the following configurations.
(1) An information processing apparatus comprising:
   at least one processor to implement
   a selection unit configured to select r sample colors from among n sample colors, where n and r are both positive integers and n>r;
   a first acquisition unit configured to acquire RGB values that an imaging device outputs when the imaging device captures, in an image capturing environment,
   an image having each of the r sample colors selected by the selection unit;
   a second acquisition unit configured to acquire XYZ values that are obtained when the r sample colors selected by the selection unit are observed in an observation environment;
   a conversion information calculation unit configured to calculate conversion information for converting RGB values into XYZ values, based on the RGB values acquired by the first acquisition unit and the XYZ values acquired by the second acquisition unit; and
   an error calculation unit configured to calculate an error in the conversion information calculated by the conversion information calculation unit,
   wherein the selection unit is configured to select r sample colors from n sample colors, based on the error.
(2) The information processing apparatus according to (1), wherein the selection unit is configured to select r sample colors from n sample colors such that the error is minimized.
(3) The information processing apparatus according to (1) or (2), wherein the first acquisition unit is configured to calculate RGB values that the imaging device outputs when the imaging device captures an image of the r sample colors selected by the selection unit, based on spectral reflectance characteristics of each of the r sample colors selected by the selection unit, spectral sensitivity characteristics of the imaging device, and spectral distribution characteristics of an imaging light source in the image capturing environment.
(4) The information processing apparatus according to any one of (1) to (3), wherein the second acquisition unit is configured to calculate, based on a color-matching function, XYZ values that are obtained when each of the r sample colors selected by the selection unit is observed by using spectral distribution characteristics of an observation light source in the observation environment.
(5) The information processing apparatus according to any one or (1) to (4), wherein the at least one processor is further operable to implement:
   a third acquisition unit configured to acquire accuracy evaluation RGB values that the imaging device outputs when the imaging device captures an image of accuracy evaluation sample colors in the image capturing environment; and
   a fourth acquisition unit configured to acquire accuracy evaluation XYZ values that are obtained when the accuracy evaluation sample colors are observed in the observation environment,
   wherein the error calculation unit is configured to calculate an error in the conversion information by using the accuracy evaluation RGB values and the accuracy evaluation XYZ values.
(6) The information processing apparatus according to (5), wherein
   the third acquisition unit is configured to calculate the accuracy evaluation RGB values, based on spectral reflectance characteristics of accuracy evaluation sample colors, spectral sensitivity characteristics of the imaging device, and
   spectral distribution characteristics of a light source in the image capturing environment, and
   the fourth acquisition unit is configured to calculate, based on a color-matching function, the accuracy evaluation XYZ values by using spectral distribution characteristics of a light source in the observation environment.
(7) The information processing apparatus according to (6), further comprising a conversion unit configured to convert the accuracy evaluation RGB values into XYZ values or convert the accuracy evaluation XYZ values into RGB values by using the conversion information,
   wherein the error calculation unit is configured to calculate an error in the conversion information by comparing the XYZ values converted from the accuracy evaluation RGB values by conversion unit with the accuracy evaluation XYZ values or by comparing the RGB values converted from the accuracy evaluation XYZ values by the conversion unit with the accuracy evaluation RGB values.
(8) The information processing apparatus according to (7), wherein the error calculation unit is configured to set a target of error calculation, based on a target of color reproduction or an application field of the conversion information.
(9) The information processing apparatus according to (8), wherein the error calculation unit is configured to assign a weight to each sample color in accordance with the target and calculate an error.
(10) The information processing apparatus according to any one of (7) to (9), wherein, when comparing the XYZ values converted from the accuracy evaluation RGB values by the conversion unit with the accuracy evaluation XYZ values, the error calculation unit calculates a first set of two-dimensional xy coordinates for the XYZ values converted from the accuracy evaluation RGB values and a second set of two-dimensional xy coordinates for the accuracy evaluation XYZ values and then calculates at least one of (i) a sum of differences between corresponding coordinates of the first set and the second set, (ii) an average and a standard deviation of differences between corresponding coordinates of the first set and the second set, (iii) a sum of absolute values of differences between corresponding coordinates of the first set and the second set, or (iv) an average of absolute values of differences between corresponding coordinates of the first set and the second set and a standard deviation of x value differences or y value differences between corresponding coordinates of the first set and the second set.
(11) The information processing apparatus according to any one of (7) to (9), wherein, when comparing the XYZ values converted from the accuracy evaluation RGB values by the conversion unit with the accuracy evaluation XYZ values, the error calculation unit converts each of the XYZ values into an L*a*b* value, calculates a DE2000 value indicating a color difference between the L*a*b* values for each accuracy evaluation sample color, and then calculates an average, a sum, and a standard deviation of the DE2000 values for each sample color.
(12) The information processing apparatus according to (2), wherein the selection unit is configured to select r sample colors form n sample colors such that the error is minimized by using a generalized reduced gradient method.
(13) An information processing method, comprising:
   selecting r sample colors from among n sample colors, where n and r are both positive integers and n>r;
   acquiring RGB values that an imaging device outputs when the imaging device captures, in an image capturing environment, an image having each of the r sample colors selected according to the step of selecting;
   acquiring XYZ values that are obtained when the r sample colors selected according to the step of selecting are observed in an observation environment;
   calculating conversion information for converting RGB values into XYZ values, based on the RGB values acquired according to the step of acquiring RGB values and the XYZ values acquired according to the step of acquiring XYZ values; and
   calculating an error in the conversion information calculated according to the step of calculating conversion information,
   wherein the selecting step comprises selecting r sample colors from n sample colors, based on the error.
(14) A computer program, which is computer-readable and causes a computer to function as:
   a selection unit configured to select r sample colors from among n sample colors, where n and r are both positive integers and n>r;
   a first acquisition unit configured to acquire RGB values that an imaging device outputs when the imaging device captures, in an image capturing environment, an image having the r sample colors selected by the selection unit;
   a second acquisition unit configured to acquire XYZ values that are obtained when the r sample colors selected by the selection unit are observed in an observation environment;
   a conversion information calculation unit configured to calculate conversion information for converting RGB values into XYZ values, based on the RGB values acquired by the first acquisition unit and the XYZ values acquired by the second acquisition unit; and
   an error calculation unit configured to calculate an error in the conversion information calculated by the conversion information calculation unit,
   wherein the selection unit is configured to select r sample colors from n sample colors, based on the error.
(15) An information processing apparatus converting RGB values, output from an imaging device, into XYZ values by using conversion information, wherein the conversion information is calculated by using optimal r sample colors selected from among n sample colors, where n and r are both positive integers and n>r, so as to convert RGB values output from the imaging device that has captured an image comprising the optimal r sample colors into XYZ values that are obtained when the optimal r sample colors are observed in an observation environment.

### REFERENCE SIGNS LIST

100 Information processing apparatus
101 Sample color spectral data holding unit
102 Selection unit
103 RGB value acquisition unit
104 RGB value acquisition unit
105 Conversion information calculation unit
106 Accuracy evaluation sample color spectral data holding unit
107 Accuracy evaluation RGB value acquisition unit
108 Accuracy evaluation XYZ value acquisition unit
109 Conversion unit
110 Error calculation unit
201, 202 xy calculation unit
203 Weighting unit
204 Standard deviation calculation unit
301, 302 L*a*b* calculation unit
303 DE2000 calculation unit
304 Weighting unit
305 Standard deviation calculation unit
1200 Camera
1201 Communication unit
1202 Imaging unit
1203 External light sensor
1204 Processing unit
1300 Display device
1301 Communication unit
1302 Display unit
1303 External light sensor
1304 Processing unit
1401 Sample color spectral data holding unit
1402 Selection unit
1403 RGB value acquisition unit
1404 XYZ value acquisition unit
1405 Conversion information calculation unit
1407 Accuracy evaluation RGB value acquisition unit
1408 Accuracy evaluation XYZ value acquisition unit
1409 Conversion unit
1501 Sample color spectral data holding unit
1502 Selection unit
1503 RGB value acquisition unit
1504 XYZ value acquisition unit
1505 Conversion information calculation unit
1507 Accuracy evaluation RGB value acquisition unit
1508 Accuracy evaluation XYZ value acquisition unit
1509 Conversion unit
1510 Error calculation unit
1601 Sample color spectral data holding unit
1602 RGB value acquisition unit
1603 XYZ value acquisition unit
1604 Conversion information acquisition unit
1605 Conversion unit
1606 Error calculation unit
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit
2200 Color reproduction system
2210 Imaging device
2211 Imaging light source
2220 Display device
2221 Observation light source
2230 Conversion device
2240 Information processing apparatus

1. An information processing apparatus comprising:
at least one processor to implement:
a selection unit configured to select r sample colors from among n sample colors, where n and r are both positive integers and n>r;
a first acquisition unit configured to acquire RGB values that an imaging device outputs when the imaging device captures, in an image capturing environment, an image having each of the r sample colors selected by the selection unit;
a second acquisition unit configured to acquire XYZ values that are obtained when the r sample colors selected by the selection unit are observed in an observation environment;
a conversion information calculation unit configured to calculate conversion information for converting RGB values into XYZ values, based on the RGB values acquired by the first acquisition unit and the XYZ values acquired by the second acquisition unit; and
an error calculation unit configured to calculate an error in the conversion information calculated by the conversion information calculation unit,
wherein the selection unit is configured to select r sample colors from n sample colors, based on the error.

2. The information processing apparatus according to claim 1, wherein the selection unit is configured to select r sample colors from n sample colors such that the error is minimized.

3. The information processing apparatus according to claim 1, wherein the first acquisition unit is configured to calculate RGB values that the imaging device outputs when the imaging device captures an image of the r sample colors selected by the selection unit, based on spectral reflectance characteristics of each of the r sample colors selected by the selection unit, spectral sensitivity characteristics of the imaging device, and spectral distribution characteristics of an imaging light source in the image capturing environment.

4. The information processing apparatus according to claim 1, wherein the second acquisition unit is configured to calculate, based on a color-matching function, XYZ values that are obtained when each of the r sample colors selected by the selection unit is observed by using spectral distribution characteristics of an observation light source in the observation environment.

5. The information processing apparatus according to claim 1, wherein the at least one processor is further operable to implement:
a third acquisition unit configured to acquire accuracy evaluation RGB values that the imaging device outputs when the imaging device captures an image of accuracy evaluation sample colors in the image capturing environment; and
a fourth acquisition unit configured to acquire accuracy evaluation XYZ values that are obtained when the accuracy evaluation sample colors are observed in the observation environment,
wherein the error calculation unit is configured to calculate an error in the conversion information by using the accuracy evaluation RGB values and the accuracy evaluation XYZ values.

6. The information processing apparatus according to claim 5, wherein
the third acquisition unit is configured to calculate the accuracy evaluation RGB values, based on spectral reflectance characteristics of accuracy evaluation sample colors, spectral sensitivity characteristics of the imaging device, and spectral distribution characteristics of a light source in the image capturing environment, and
the fourth acquisition unit is configured to calculate, based on a color-matching function, the accuracy evaluation XYZ values by using spectral distribution characteristics of a light source in the observation environment.

7. The information processing apparatus according to claim 6, further comprising a conversion unit configured to convert the accuracy evaluation RGB values into XYZ values or convert the accuracy evaluation XYZ values into RGB values by using the conversion information,
wherein the error calculation unit is configured to calculate an error in the conversion information by comparing the XYZ values converted from the accuracy evaluation RGB values by conversion unit with the accuracy evaluation XYZ values or by comparing the RGB values converted from the accuracy evaluation XYZ values by the conversion unit with the accuracy evaluation RGB values.

8. The information processing apparatus according to claim 7, wherein the error calculation unit is configured to set a target of error calculation, based on a target of color reproduction or an application field of the conversion information.

9. The information processing apparatus according to claim 8, wherein the error calculation unit is configured to assign a weight to each sample color in accordance with the target and calculate an error.

10. The information processing apparatus according to claim 7, wherein, when comparing the XYZ values converted from the accuracy evaluation RGB values by the conversion unit with the accuracy evaluation XYZ values, the error calculation unit calculates a first set of two-dimensional xy coordinates for the XYZ values converted from the accuracy evaluation RGB values and a second set of two-dimensional xy coordinates for the accuracy evaluation XYZ values and then calculates at least one of (i) a sum of differences between corresponding coordinates of the first set and the second set, (ii) an average and a standard deviation of differences between corresponding coordinates of the first set and the second set, (iii) a sum of absolute values of differences between corresponding coordinates of the first set and the second set, or (iv) an average of absolute values of differences between corresponding coordinates of the first set and the second set and a standard deviation of x value differences or y value differences between corresponding coordinates of the first set and the second set.

11. The information processing apparatus according to claim 7, wherein, when comparing the XYZ values converted from the accuracy evaluation RGB values by the conversion unit with the accuracy evaluation XYZ values, the error calculation unit converts each of the XYZ values into an L*a*b* value, calculates a DE2000 value indicating a color difference between the L*a*b* values for each accuracy evaluation sample color, and then calculates an average, a sum, and a standard deviation of the DE2000 values for each sample color.

12. The information processing apparatus according to claim 2, wherein the selection unit is configured to select r sample colors form n sample colors such that the error is minimized by using a generalized reduced gradient method.

13. A computer program, which is computer-readable and causes a computer to function as:
a selection unit configured to select r sample colors from among n sample colors, where n and r are both positive integers and n>r;
a first acquisition unit configured to acquire RGB values that an imaging device outputs when the imaging device captures, in an image capturing environment, an image having the r sample colors selected by the selection unit;
a second acquisition unit configured to acquire XYZ values that are obtained when the r sample colors selected by the selection unit are observed in an observation environment;
a conversion information calculation unit configured to calculate conversion information for converting RGB values into XYZ values, based on the RGB values acquired by the first acquisition unit and the XYZ values acquired by the second acquisition unit; and
an error calculation unit configured to calculate an error in the conversion information calculated by the conversion information calculation unit,
wherein the selection unit is configured to select r sample colors from n sample colors, based on the error.

14. An information processing apparatus converting RGB values, output from an imaging device, into XYZ values by using conversion information, wherein the conversion information is calculated by using optimal r sample colors selected from among n sample colors, where n and r are both positive integers and n>r, so as to convert RGB values output from the imaging device that has captured an image comprising the optimal r sample colors into XYZ values that are obtained when the optimal r sample colors are observed in an observation environment.
